(19) United States
(12) Patent Application Publication
(10) Pub. No.: US 2025/0377894 A1
(43) Pub. Date: Dec. 11, 2025

(54) CONTROL FLOW AND POINTER INTEGRITY ENFORCEMENT IN A SECURE TAGGED ARCHITECTURE

(71) Applicant: The Research Foundation for The State University of New York, Binghamton, NY (US)

(72) Inventor: Kanad Ghose, Vestal, NY (US)

(21) Appl. No.: 19/216,713

(22) Filed: May 23, 2025

Related U.S. Application Data
(60) Provisional application No. 63/650,898, filed on May 22, 2024.

(51) Int. Cl. G06F 9/38; G06F 21/62

(52) U.S. Cl. CPC G06F 9/3802; G06F 21/6281

(57) ABSTRACT

Control flow attacks exploit software vulnerabilities to divert the flow of control into unintended paths to ultimately execute attack code. Instruction and data tagging is used to thwart such control flow attacks, including violations of pointer integrity. Narrow-width data tags along with narrow-width instruction tags interspersed with the instructions and data facilitates security policies. Co-locating instruction tags close to their corresponding instructions within cache lines eliminates the need for separate mechanisms for tag accesses. The tags are generated based on analysis during compilation.

### CROSS REFERENCE TO RELATED APPLICATIONS

The present application is a Non-Provisional of, and claims benefit under 35 U.S.C. § 119 (c), from U.S. Provisional Patent Application No. 63/650,898, filed May 22, 2024, the entirety of which is expressly incorporated herein by reference.

### GOVERNMENT SUPPORT STATEMENT

This invention was made with government support under Contract No. HR0011-18-C-0012, awarded by DARPA. The government has certain rights in the invention.

### FIELD OF THE INVENTION

The present invention relates to the field of secure tagged microprocessors, and more particularly to a secure tagged processor with rigorous tagging for each instruction and datum.

### INCORPORATION BY REFERENCE AND INTERPRETATION OF LANGUAGE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage.

### BACKGROUND OF THE INVENTION

Recent years have seen significant growth in attacks targeting inherent vulnerabilities in software. Control-flow attacks (CFA) change the control flow path from what was originally intended to other paths that will ultimately execute malicious code. Examples of control flow attacks range from stack smashing [47], format string attacks to the family of code reuse attacks that include return-oriented programming [7], [53], [55], jump-oriented programming [9], [13], return-to-libc programming [61], and counterfeit object oriented programming [52].

Tagged architectures have been proposed as a basis for many hardware-based security solutions against various exploits such as control flow attacks and memory corruption in general. The width of the tags in a tagged architecture determines a tradeoff between the level of protection offered and performance. Schemes that use 1-bit tags, such as HDFI [56], where one bit data tag is used to identify a single control flow related entity, incur small performance overhead. However, distinguishing between forward and backward control flow edges is not possible using a single bit. The other extreme of the tag width is found in architectures such as PUMP [26], and DOVER [24], where metadata tag widths are identical to the data or instructions that they are associated with. Such wide metadata tags enable a rich and sophisticated set of security mechanisms but discourage the deployment of the tagged system due to the associated performance and storage overhead. Tag widths between these two extremes are much more useful for practical systems as they provide the right balance between the hardware-supported security mechanisms and performance.

US20220121738 provides methods, systems, and computer readable media for main memory tag compression. Some aspects of the present subject matter described herein relate to enforcing security policies in processor environments with compact metadata memory requirements by utilizing short tags (e.g., 16-bit tags that are smaller in size than a pointer size needed to solely convey a memory address containing metadata) in main memory to reduce memory requirement. Further, some aspects of the present subject matter described herein relate to various methods, techniques, mechanisms, and/or systems for using main memory tag compression by translating, deriving, and/or converting a short tag into a full tag or long tag (e.g., 64-bit) that indicates a memory address containing metadata.

The Security Tagged Architecture Co-Design (STACD) initiative focused on eliminating inherent software vulnerabilities by redesigning the underlying hardware and the operating system to enforce software security policies and semantics. The proposed approach uses a metadata processing unit known as the Tagged Management Unit [or Tag management Unit] (TMU) that operates concurrently with the Central Processing Unit (CPU) to process the metadata. The introduction of tag-capable hardware requires software that uses tagged information.

ST-ZKOS implements a 32-bit tag that is paired with each 32-bit word in memory. This effectively cuts the amount of memory. There are three primary fields: Owner Field—this field indicates the entity that owns the resource managed by the code module. All code and data on the system have been separated into code modules that perform specific functions based on the concept of least privilege. An example of a code module would be the garbage collector, or a device driver. Code-space Field—this field indicates the code modules that are currently executing and/or the code modules that are authorized to access specific operating system resources. Control-bits Field—this field is used to even further support least privilege by providing some typing and access control information to system resources.

Each component on the bus would be associated with a single owner at any given time. Any master component owned by one entity would not be able to read/write from/to any slave component owned by another entity. Additionally, since the provenance of all components and the intent of their designers cannot be guaranteed, permission from the controller is required for component to accessing the bus (read or write), except for access requests. The bus width was widened to permit the 32-bit tag to accompany the associated code and data. In order to associate each component on the bus with a specific owner, the components needed a way to identify who their owner is. The owner field of the tagging scheme allows each component to identify an owner. The other fields of the tag are used by the tag management unit to indicate what rules the data/code must follow in the processor and are not relevant for the interconnect.

The software requires means to set the tag value for each component, thus identifying the owner. To accomplish this, the plug and play information for each component is stored in a record array in the arbiter of the controller. The arbiter needs to be modified such that this array is now memory mapped so that software can address it to assign tags for each component. When a master component, after having been granted sole access to the bus, writes data to a specific address, the arbiter will interpret the address to identify which slave component should receive the data, and will also compare the tag of the master with the tag of the slave from the memory mapped array to determine if they are owned by the same entity. If they are not, then the arbiter reports an error and cancels the transaction. Most memory components are shared among various owners.

Software needs to ensure that one owner does not attempt to overwrite the memory locations of another owner. The arbiter will not perform tag checks on writes to memory, such as Direct Memory Access (DMA) writes. For DMA writes, the arbiter will assign the master's tag to all data from the master on the tag bus to memory. This approach allegedly does not sacrifice security as the new data is tagged appropriately according to the owner of the master. Therefore, it is important that software assign the tag appropriately. The arbiter performs tag checks on reads from memory when the requesting master is not a processor. If the requesting master is not a processor, then the tag of the data is compared to the tag of the requesting master. If the tags do not match, then the arbiter initiates an error response and terminates the transaction.

The memory word may be, for example, 32-bits wide memory word for the following discussions, as in the 32-bit version of RISC-V. In the prior art, each of the 32-bit memory words has an associated 8-bit tag. (According to the present technology, 8-bit tags are employed for 32-bit instructions, and 2-bit tags are employed for 32-bit data). Of course, the technology is not limited to 32-bit architectures, 8-bit tags, or RISC-V architectures, and the technology may explicitly include CISC architectures. Likewise, the technology may encompass 4, 6, 8, 12, 16, 32, and 64-bit architectures, and other less standard word-lengths. The tags may be 2, 4, 8, 12, 16, 24, 32, 48, or 64-bits, for example.

For data words, the tag indicates the data type and allowed access mode. For 32-bit memory words containing instructions, the 8-bit tag indicates, for example, how the instruction can or cannot be used, and in some cases if the instruction has any special significance or characteristic. The tags are interpreted during execution by tag processing units provided associated with the instruction decoder and/or processing units. The tag processing units (as well as optional tag storage, transfer, security, etc., hardware) distinguish the SP from typical processor architectures. Note, however, that is possible in some architectures to implement the SP system without hardware modification, though microcode enhancements. However, in order to achieve minimal impact on processor throughput, and freedom from reliance on trusted software, hardware support and acceleration is preferred. Because the processor cache is preferably designed to have bitlines dedicated with tags, in some cases, it is possible to commence processing of the tags while in situ within the cache. For example, various tests and flag operations may be conducted before the instruction is fetched from the cache into the instruction decoder. In asymmetric processor designs, the tags may also help steer sequences of instructions to preferred processing resources.

In some cases, data tags can get updated as the result of execution of an instruction. Preferably, programs, i.e., sequences of tagged instructions, have no ability to overwrite the tags directly: tag usage and tag updates are intrinsic to the instruction semantics, and for example are immutable defined by the compiler. Tags on critical data and instructions can also be marked as immutable and/or unreadable to prevent the misuse of instructions and data. Tags are preferably only manipulable under software control by a single trusted module. However, some applications require increased flexibility or suffer from different types of challenges, and a blanket prohibition on post-compilation tag modification would be counterproductive.

The SP may separate instruction and data pages for security and to simplify addressing. In some embodiments, outside of the cache, tags are stored in pages separate from the data, and code pages and the tag pages are marked as non-readable, non-writeable and non-executable. Only trusted tag manipulation logic and the SP hardware can access/update these pages. As in any normal processor, page protection bits are associated with each page (and stored within TLB entries) that indicate the permitted access modes (read, write, execute). However, this segregation is not required in all implementations.

The SP relies upon a trusted compiler, linker and loader, which take care of tag generation, tag loading and linking modules. In separated tag pages, an integrity check is performed immediately after booting to ensure that tag pages were not altered during forced disruptions in the booting phase. In interspersed storage, a digital signature of a sequence of instructions and associated tags may be used to ensure validity and lack of tampering. Data will typically be dynamically variable at runtime, and cannot generally be validated in this fashion.

According to the prior art, tags in SP are encoded and interpreted in context, depending on whether the page is an instruction page or data page. Data tags indicate the type of data in the associated word and/or, in some cases, how the data is to be legally used (e.g., as a return address or as the target of an indirect branch or as a pointer). Instruction tags are used to enforce control flow to legal paths, to enforce legal ways to call and return from functions and protected domains or modules and enforce legal data operations based on the source data type as well as bounded accesses to fenced memory regions. Note that, in effect, the instruction tags extend the ISA by designating specific context-dependent variant of some existing instructions. This, in effect, permits the extensions to be retrofitted into an existing datapath relatively easily.

### Metadata Tags

Metadata tags (MDTs) in SP are in line with the code as a 32-bit tagged entity, and such tags carry information used for access control, control flow integrity markers for indirect branches, information about local validated exception handlers that can be quickly invoked within a function. When a single MDT is not enough to convey the information needed, a sequence of metadata tags with appropriate indicators for the contents and flags to indicate the start and end of the sequence can be used. MDTs are generated by the compiler and are marked as immutable by all software, excepting the trusted software module that updates tags. MDTs can be implemented as 32-bit words tagged [EMD] that are embedded within the code. The 32-bit metadata word contains other indicators that specify its remaining contents. Embedding metadata within code makes it possible to exploit the temporal and spatial locality in accessing instructions.

The MDT containing access information within a code segment can include the security or privilege level of the code segment and can be compared against the caller's privilege level to implement class-based access control (e.g., MLS). Alternatively, or in addition, MDTs used for access control can include pointers to access control lists (whitelist and/or blacklist), permitted access mode to data private to the called segment. MDT s are also used for specifying local exception handlers, invoked essentially as a function call. Note that from the standpoint of the baseline processor, the MDTs are effectively NOPs (No-operation instructions) and are interpreted only by the tag processing logic.

Fenced Protected Regions with Automatic Bounds Checking

The SP permits memory regions to be fenced with automatic bounds checking. Virtual pages containing these regions are marked as not-readable, not-writeable, so that normal memory instructions are incapable of accessing such protected regions. Only memory instructions (such as LOADs and STOREs in a RISC ISA), specifically tagged by the compiler can access these fenced regions using a specified bounds register which demarcates the memory region. Memory accesses using such tagged instructions automatically force a SP hardware check of the effective memory address to ensure that the memory accessed falls within the region specified in the bounds register. Each bounds register has the following fields: (a) a start address S indicating the starting address of the fenced region in virtual memory; (b) an offset limit L that indicates the size of the data structure. The highest accessible address in this region is S+L−1; and (c) the access mode in which this data structure can be accessed-one of: read-only, write-only, read and write. Four such bounds registers are provided in SP, BRO through BR3.

The information to be loaded into each bounds register is stored in two adjacent memory words tagged as “Secure Pointer 0” and “Secure Pointer 1”. The first of these two words contains the starting address of a secured data region containing sensitive data while the second word contains the segment register id of the segment containing the data, the offset limit and the access mode. The tags and contents of these words are generated at compile time and both words are immutable and unreadable by normal software. The compiler uses bounded pointers and specifically-tagged instructions, tagged [FMA] to perform secure accesses in the least privileged mode to a fenced contiguous memory region, going through an automatic bounds checking in hardware. Another special instruction tag ([LBR]) is used with a LOAD to permit secure pointers to be loaded into the specified bounds register.

Specifically, [LBR] LOAD<BRid><reg><offset>, tagged to indicate that this is a LOAD capable of loading a bounds register with secure pointers (tagged as [SP0] and [SP1]) is used to load the bounds register specified in <Brid>with the bounds of a fenced memory region. Alternatively, we can have bounds registers implicitly associated with a particular load (via some hardware-maintained mapping information), or have bounds registers identified via fields in the tag of the LOAD instruction.

The effective memory address targeted by this LOAD is computed by adding the contents of an existing architected register specified in <reg> to the literal value specified in offset. The address so computed should point to a memory word tagged as “SP0”. The contents of this memory location, if the tag check passes, are loaded into the appropriate field of the specified bounds register. Next, the effective word address is incremented and should point to a memory word tagged as “SP1”. If the tag check passes, the contents are loaded into the respective fields within the specified bounds register. If either or both tag checks fail, an exception is generated. An alternative mechanism for loading, respectively, the two secure pointers (“Secure Pointer 0” and “Secure Pointer 1”) into a bounds register can use two separate LOAD instructions to load these pointers into a bounds register as follows:

[LBR0] LOAD <BRid> <reg> <offset1>
[LBR1] LOAD <BRid> <reg> <offset2>

Where the value of <offset2> is obtained by adding the value specified in <offset 1>with the size of “Secure Pointer 1”. Note also that two separate tags are used for the two LOAD instructions, LBR0 and LBR1. The hardware implementing the LOAD tagged with LBR0 checks, in addition to all other checks as described above, if the pointer type being loaded matches the tag associated with Secure Pointer 0. A similar tag check is done for the LOAD tagged with LBR1 to check compatibility with “Secure pointer 1”. The two secure pointers can have distinct associated tag values to enable this check.

To access a fenced memory region, LOAD and STORE instructions, tagged as [FMA] can access a fenced memory region. Specifically, [FMA] LOAD<reg>, <Brid><offset>performs a load into the architectural register specified in <reg> by adding the contents of the “base” field of the bounds register specified in <BRid> and the offset. Note that in a normal LOAD instruction, the field used by <BRid>specifies an architectural register, whereas for a [FMA] LOAD, the same field specifies a bounds register. Before the memory access is actually performed, the following three checks are performed to ensure that: (a) the resulting word address is confined within the memory region specified in the bounds register; (b) if a read access is permitted as specified in the bounds register; and (c) the targeted memory word is tagged as readable.

An exception is generated if any of these conditions are not valid. The instruction [FMA] STORE<reg>, <BRid><offset> is the variant of a normal STORE and is used to write to a fenced memory region after checks similar to that of a [FMA] LOAD.

### Protected Domains for Isolating Sensitive Data or Resources

Protected domains in SP encapsulate functions and sensitive data, including private data, and safeguard against unintended information leakage. Some of these functions within a protected domain are callable from external entities, including other protected domains, provided they have the appropriate privileges. These calls are cross-domain and take place through secure entry points, passing parameters through special registers. Cross-domain calls in SP use accesses to parameters passed to the called function and data inside the domain accessed by the function called in the least necessary access mode, as determined by the SP compiler or by using default policies. To complete the controlled, validated cross-domain call mechanisms, a separate call stack is used inside the protected domain as the called function executes. When the cross-domain call returns, this stack is cleared automatically to prevent any information leakage to the subsequent cross-domain calls.

The implementation of protected domains in SP relies on the tagging mechanism. A single segment encapsulates the code for a protected domain. Domain-local data and the local stack can also be implemented within this segment. Alternatively, these structures can be implemented as fenced regions with bounded pointers, with the secure pointers stored inside the domain's code segment. The cross-domain call transfers control to the callee using a protected, unresolved pointer. Data private or exclusive to the called domain are protected using fenced, bounds checking. Input parameters may be similarly protected. Legal entry points are tagged as such and all other instructions in the domain are marked as non-enterable to prevent illicit calls. In-line metadata tags are used to verify the caller's privileges on entry through these legal entry points.

### Fully Isolated Protected Domains

The broad mechanism described above implements a fully-isolated domain. A fully-isolated domain provides full-fledged isolation guarantees and protection, and is implemented as a segment not known and not directly accessible to the caller. Cross-domain calls use a modified system call (or a new instruction, depending on the ISA targeted), specifying an appropriately tagged domain ID and a function offset in a sealed cross-domain pointer that essentially behaves as a capability, both specified in a single word tagged as “unresolved” domain function pointer. The domain ID is translated to a segment address by an underlying trusted system call handler.

Control transfer to an isolated domain, after appropriate tag validation of the tagged and modified system calls and unresolved pointer takes place as follows.

First, the call parameters are saved in special registers and the trusted system call handler translates the domain ID to an internal address.

Next, control is transferred to the specified entry point, where access checks are performed. Subsequently, a new context (that is, call stack) is allocated to serve the call. Such context stacks can be statically or dynamically allocated [20,46] and on exit, the context pages are cleared by marking the associated tags as invalid. This clearing is necessary to prevent information in the call stack from leaking to the next caller indirectly.

To complete the protected call, after validating the legitimacy of the caller from the access control information, the input parameters are copied from the parameter register into the newly-allocated context stack and the incoming parameter registers are cleared.

The above steps indicate that the overhead of a call to a fully-isolated protection domain is relatively expensive compared to a normal function call, as domain ID translation, context allocation are needed on an entry and context clearing is needed on an exit. Parameters in a cross-domain call to a fully isolated domain are passed through special registers as scalars or as pointers to pointer secured bounded segments, whose pointers are kept in the special parameter register set. The qualifier “fully-isolated” alludes to the higher level of isolation achieved between the caller and the callee using unresolved domain pointers, separate call stacks and automatic stack clearing on exits.

From an implementation perspective, cross-domain calls to fully-isolated domains can benefit from a number of optimizations that will be explored in this effort. Examples of these optimizations include the in-lining of domain IDs of frequent callers or storing them in a local hashed data structure, use of the encryption engine within the memory controller to keep private data encrypted in memory, and decrypt them when they are fetched into the registers, or encrypt register data when they are stored into memory. Finally, the access control functions using the information in metadata can be implemented in microcode or in software, that can use an approach similar to the one for fast local exception handling described later.

### Lightweight Protected Domains

Somewhat moderate isolation can be implemented as a lightweight cross domain call where the protected domain is a segment co-mapped to the address space of the application that uses functions within the domain. A call to a function in a co-mapped domain is implemented by a JUMP instruction tagged by the compiler as a cross-domain transfer primitive. These JUMP instructions are immutable. The offset used in the JUMP is set by the compiler to the offset of a legal entry point. The address to be used is also tagged as a “resolved” domain pointer which can be only used by JUMPs tagged as a cross domain transfer instruction. The resolved domain pointers cannot be overwritten or copied, like words tagged as return addresses. They are only usable without restriction by trusted code within the system. An exception is generated if the target of the JUMP used for cross-domain call does not target a legal entry point, which has to have an instruction tagged as an entry point. Instructions within a protection domain that are not at legal entry points are tagged as “domain-sealed”. With co-mapped domains, a traditional activation stack (that is, call stack) can be used, making calls to functions within a co-mapped domain have an overhead identical to a normal function call.

### Protected Domains

Critical systems functions and critical databases are examples of entities that demand the use of a fully-isolated domain for protection.

Protection domains represent a way of implementing security compartments that contain executable code. Access to the code within a compartment is enabled through predefined entry points and only if the caller has the right access privileges. From the usage perspective, the choice between a lightweight domain and a fully-isolated domain is determined largely by the level of isolation needed.

The SP permits one or more protection domains to be set up within the user space or within the systems space. Domains in SP are functionally identical whether they are in the user space or system space. A single application may be written to incorporate multiple protection domains in the user space. Similarly, the OS itself can be decomposed into multiple domains.

A simple decomposition breaks down the system into domains corresponding to core kernel functions, other kernel function, trusted tag manipulation module, system calls, Virtual Machine Monitor (VMM), individual libraries, individual utilities such as trusted linkers, trusted loaders, trusted compilers, etc. The hardware support is required to implement and enforce the address limits of the domain, confining address calculations performed with a segment base register in the virtual address to addresses within the domain.

### Fast Local Exception Handling

In some cases, security checks can be quite elaborate and need to be performed in software. Such checks can be done using a function local to a protection domain that can be invoked with low overhead on a tag-generated exception. The existence of a local trap is indicated by inserting a metadata tag, preceding the code that uses the data, to indicate that a local handler exists for specific exception types. The in-lined metadata words at the beginning of this function where the exception is generated, passes on the address of the handling function and the type of exception it handles, to the underlying SP control logic. When the function generating the exception returns, the local exception function is disabled by another metadata tag (tagged [EMD]) inserted by the compiler to precede the return instruction, reverting exception handling responsibilities to the system-provided handler.

RAKSHA also provides local handlers, but in the SP according to the present technology, their scope is additionally limited only to the function where they are specified for added security. Local exception handling for security checks can be used for dealing with SQL injection.

### Keeping Track of Lowest Privileges in a Protected Call Chain

A call to a protected domain performs the necessary access checks, but it may be useful in some situations to keep track of the lowest privileged domain in the call chain. This information is passed on to the callee through an extension of the cross-domain parameter transfer register and saved in the context stack allocated for the call. With a dynamic, privilege-based security policy, where policies need to be changed on-the-fly, the privilege level of the protected domain with the lowest privilege in the call chain can be used in software to identify and deal with any unintended violation.

More generally, the tag in each case may be arbitrarily extensible through reference to an optional additional tag, register, stack entry, or memory location. Thus, the tag may be limited to 8 bits, but include “extensions” as required.

### Crypto Engine and Per-Thread Key Registers

To permit fast encryption and decryption in the memory access path for data going out to memory or fetched from encrypted memory regions, the SP may incorporate a memory encryption and decryption engine within the memory controller. Memory access instructions (such as LOADs and STOREs) tagged as [ENC] may invoke memory encryption or decryption when a line is fetched from memory or written to memory.

This cryptographic processing capability may be used for other features, and thus need not be dedicated to the SP functionality only, though preferably the cryptographic key(s) used for SP is distinct from key(s) used for other purposes. Likewise, key management for the SP functionality key(s) is restricted to hardware and/or specially privileged software.

For example, memory writes to cache lines that need to be encrypted before being written to memory are marked within the cache using a bit flag and encryption takes place when such lines are evicted from the cache. This flag accompanies the line to the memory write buffer and is examined by the memory controller to decide if the line needs to be encrypted prior to the write.

The SP also incorporates a per-thread key register that is used to hold the key for the encryption. The key registers are loaded by a trusted kernel module when the thread is scheduled.

The present approach provides cryptographic protection in two areas: software requested cryptographic operations and cryptography embedded in the hardware to support the SP architecture tag and data security. A cryptographic block is provided for software use. The software cryptographic engine block enforces protocol compliance to eliminate common misuse of cryptographic operations. Cryptographic keys are isolated from software access and provide the capability to generate unique power-on keys to protect data at rest.

The embedded cryptographic processing utilizes high speed encryption/decryption engines and hash capabilities for protecting the various tags and vulnerable memory areas defined in the SP architecture from modification and inadvertent data exposure. In addition, the solution provides flexibility for future enhancements by enabling integration of commercial Physically Unclonable Functions (PUFs) to provide unique per part protection, verification and authentication of data. This combination of enhancements is utilized to eliminate attacks on the cryptographic operations.

### Memory Mapped IO Devices and Taint Tagging

The SP maps all IO device registers to the memory space and protects accesses to them using special tags [MCM, MCI]. For added protection, these can be private to drivers that are implemented as a protected domain.

The SP also implements taint propagation. Any IO device that can import potentially suspect data performs the DMAs into area word-tagged as [INV], or invalid. Any use of such data triggers exceptions that validates the data type in software, and once validated, copies it into the appropriate memory locations with proper tags. Byte sequences coming in from potentially compromised sources, such as a network interface, will be stored as a sequence of words tagged with [TBS] or, as a potentially tainted byte string components, with null byte pads to round up to a word size. Any operation using an input tagged as [INV] or [TBS] propagates the same tag to the result (both value and flags such as carry, zero, etc.). Overflows, underflows and results produced using inappropriate types of input operands will also taint the result produced by tagging it as [INV].

### Security Provided by SP

The SP relies fundamentally on the integrity of the word-tagging mechanism and in-line metatags (which are also word-tagged). This is realized by making tags inaccessible to software. The only exception to this is a high-privilege trusted software module that can manipulate the tags. SP also assumes that the compiler, linker and loader are trusted, as the compiler is responsible for the tag generation and the linker and loader are responsible for loading the word tags in a secure memory area inaccessible to all but the trusted software module that can manipulate tags. The hardware, of course, is also assumed to be secure as it interprets the tags. Attacks during booting or tag loading by induced interrupts that can potentially corrupt the tags are addressed by validating the hash signature of the tag pages prior to execution.

Instruction tagging in the SP, to enforce their context-dependent legal use, a distinctive feature of the SP, provides the basis for enforcing control flow for functions calls and returns and for directing indirect jumps to legal targets. The SP also disallows data to be interpreted as instruction—this is the basis for preventing several attacks. At the same time, to permit legal code modifications in interpreters and during the boot loading of some OSs, the functions performing such modifications are vetted out and validated at run-time using tags.

Data areas secured with bounds checking and accessed in the least-necessary access modes use secure pointers and specially-tagged memory instructions, making it impossible for normal memory instructions to access such fenced areas, which are implemented in pages marked as non-readable and non-writeable (and non-executable).

Protection Domains (PDs) in the SP for encapsulating data, associated private and public functions, are invoked only through compiler-directed control instructions (tagged as such) and invoke domain functions through legal entry points by ensuring that the control transfer to such domains from the caller take place at instructions tagged as entry points. PDs are entered only after validating the eligibility of the caller at the entry point using in-line metadata tags that point to access control information or has embedded access control information. This guarantees that only legitimate callers can invoke the PD's public functions. PDs allocate a call-specific context (call stack) on each call and can also use optional encryption for any private data in the RAM, facilitated by a master key maintained in the per-thread key register and memory encryption/de-encryption engine. All of these features permit PDs to implement security compartments and guard against unintended data leakage.

### Examples of Security Provided by SP Against Software Vulnerabilities

The protection provided by the SP may be provided against exemplary weaknesses from various CWE (Common Weakness Enumeration) classes as listed by Mitre Corporation.

The following table lists how exemplary instances of the seven classes of CWEs are handled in SP. Tags are shown, where used in square brackets. Additionally, the SP compiler avoids vulnerabilities by using proper libraries, vetted functions and trusted system functions.

TABLE 1
Exemplary Weaknesses

| CWE Class | Examples | SP Mechanism Addressing CWE |
|---|---|---|
| Buffer errors | Stack attacks including ROP | Instruction and return address tagging |
| | CWE119: improper restriction of | Bounds registers implementing fenced |
| | operation within memory area | memory area |
| | CWE120: buffer copying without | |
| | checking buffer size | |
| Permissions, | unnecessary privilege | Access-controlled protection domains, |
| privileges, access | CWE-250: execution with | |
| control | CWE-306: missing authentication | access to data in least-necessary mode |
| | of critical functions | |
| Resource | CWE-732: incorrect permission | PD encapsulating resource + memory |
| management | for critical resources | encryption, memory-mapped, tagged |
| | | device control registers in fenced area + |
| | | BR |
| | CWE-22: Improper Limitation of | Word tagging to taint input arguments and |
| | a Pathname to a Restricted | software handlers on using tainted |
| | Directory, | arguments |
| | CWE-494: Download of Code | |
| | Without Integrity Check | |
| Code injection | JOP | Tagging of jumps, jump table entries, |
| | | targets + CFI markers in in-lined MD |
| | Executing data as instructions | Data word tags disabling execution + |
| | | separate data and instruction pages |
| | CWE-89: SQL injection, CWE- | Word tagging to taint input arguments |
| | 79: cross-domain scripting | [TBS] and software handlers on using |
| | | tainted argument words of byte sequence |
| Information | Information exposure through | Access controlled PDs, tag marking data |
| leakage | error message (CWE-209), debug | as sensitive, memory encryption |
| | (CWE-215), caching (CWE-524), | |
| | log files (CWE-532) | |
| Crypto error | CWE-306: missing authentication | Access controlled PDs, encryption-needed |
| | of critical functions | tag [ENC] |
| | CWE-327: use of broken crypto | Force use of hardware crypto engine, |
| | | master key in per-tread key register |
| Numeric errors | Operations on incompatible | Data type enforcement through tagging, |
| | operands | tagging result produced as [TAI] |
| | CWE-682: Incorrect Calculation | Tagging result produced with |
| | | overflow/underflow as tainted [TAI] |
| | CWE-198: Use of Incorrect Byte | Words in byte sequence from external |
| | Ordering | sources marked as tainted [TBS], invokes |
| | | handlers on use. Other situations handled |
| | | by compiler. |

Example details on how SP handles some vulnerability classes are discussed below.

### Buffer Errors

In SP, buffer errors are avoided by using protected fenced memory regions in general. In buffer overflow attacks that center on a stack and compromise function call and return control flow, word and instruction tags detect control flow compromises as follows. The key idea here is to enforce that the return from a function uses a legitimate return address from the call stack and that control returns to the instruction immediately following the call instruction (implemented using a JALR or JAL on the RISC-V). The SP accomplishes this as follows:
The control logic implementing a Call instruction is augmented to tag the return address pushed onto the call stack as a “return” address. The return address tag is generated only by the Call instruction. The return address tag also marks the word as immutable (that is not overwriteable) and permits only a return instruction (tagged appropriately) to use this return address. Word tagged as a return address cannot also be copied (for instance by using a LOAD).
The instruction following a call, which is the point of return, is tagged by the compiler as the target of a return.
The Return instruction or the JUMP instruction implementing a function call return is tagged as a “return” instruction by the compiler.
Control flow returns only when the target address on the call stack is marked as a return address and the next instruction executed is marked as the target of a return. A successfully executed return also resets the stack location associated with the return address used to permit overwrites during subsequent usage.

For relocation of stacks and context switches, tag checking is turned off momentarily by a trusted code and stack words, including words tagged as a return address can be copied and written elsewhere.

This simple data word-tagging and instruction-tagging mechanism prevents the simple “stack smashing” attacks as well as libc attacks [40], and more sophisticated return-oriented programming attacks that all use buffer overruns to overwrite return addresses on the attack. Overwrites to stack locations that hold the return address are prevented, and raise an exception because of the “return” address tag, which prevents overwrites and copying. Further, for libc and ROP attacks, arbitrary gadgets cannot be constructed, as the instruction at the point of the misdirected return is not tagged as a legitimate instruction following a call by the compiler in general.

The tag-based implementation of proper function call and return control flow has significant advantages compared to shadow stacks that provide similar functionality. The shadow stack mechanism essentially saves the return address at the time of a call on a separate shadow stack. At the time of a return, the return address used for the normal call stack is compared against the return address saved on the shadow stack and an exception is triggered on a mismatch. The shadow stack needs to be implemented in a protected area and also needs to be saved and restored on context switches. SP eliminates the need to implement and manage a shadow stack across context switches. The mechanism also imposes zero performance overhead (i.e., the protection mechanism does not add any execution overhead when the security checks pass, other than the performance degradation caused by additional accesses to tags, which are mitigated using the encoded tag cache hierarchy and tag perfecting), and is far less complicated than exotic architectural support that has been proposed for detecting ROP attacks.

### Enforcing Control Flow for Indirect/Computed Branches

The legal targets of an indirect jump are all tagged as such at compile time. When an indirect jump executes, the tag of the target is verified to be marked as a target for the indirect branch; an exception is generated if the indirect branch attempts to transfer control to any instruction that is not marked as a target. Jump-oriented programming attacks that construct attack gadgets by stringing together existing instruction chunks through the modification of targets of indirect jumps are thus not possible. Again, the SP is far simpler compared to proposed solutions like, or the use of special instructions at the target of indirect branches, as in a recent Intel solution, and has a zero-performance overhead.

Note that with the SP tagging scheme, it is still possible for an indirect jump to legally transfer control to the marked target of another indirect jump. Although this would be a relatively difficult exploit, the SP can protect against this by storing an in-line metadata tag at the target that holds a unique-compiler-generated label derived from the indirect branch's virtual address. This metadata-bearing word is followed by the original instruction at the target. Control transfer is allowed only after validating this label and ensuring that the jump target is labeled as a legitimate target. This approach is similar to what has been used for enforcing control flow integrity in software.

### Protecting Transfer Vectors and Function Pointer Tables

A class of attacks redirect control flow from the intended path by altering the address of virtual functions used by many programming languages (for example, Vtable attacks for C++ programs) or jump vectors stored in jump tables by the linker for dynamically linked code modules. Tagging these table entries as immutable jump table entry prevents them from being overwritten by malicious code and also ensures their proper use by jump instructions.

### Preserving Code Integrity

At the page level, data segments have an associated NX (no-execute flag) for each page within the segment. In addition, instructions are tagged as immutable by the compiler, so they cannot be altered. Together, these mechanisms ensure code integrity is preserved. However, there are legitimate reasons for using run-time code modification in current systems. Many OSs use self-modifying code at boot time for booting off a small image. Similarly, bytecode interpreters in languages such as Java rely on code modification for performance optimization. A solution to permitting these undesirable legacy practices is to validate the code that performs this on-the-fly modification, and rely on the trusted software module that can directly access and update the tags before and after modification. To do this, the permitted functions that modify the binaries at run-time are implemented within their own protection domain and they are permitted to call functions within the domain runs the functions that perform the code modifications. This permission is granted through explicit entries in an access control list for the protection domain that implements the tag updates.

### SQL Injection and Cross-Domain Scripting

Both SQL injection and cross-domain scripting vulnerabilities stem from the use of potentially tainted inputs. The SP marks such inputs as tainted with the word tag [TAI]. Byte sequences are put into words, and the constituent words bear this tag. The SP does not rely on hardware to perform the validation of arguments, as the process is very complex. Instead, any attempt to use such tainted arguments trigger a context-specific check by a handler. In some cases, the handler may be encapsulated in the domain where the argument is processed or used, and is invoked through a locally-handled trap as a function call with low overhead. As an example in the case of SQL injection, the SQL database and its associated functions can be encapsulated in a protection domain with a handler to check the byte string passed on as argument. On exit from the validation function (which will typically call trusted functions for validating the argument as legal, for example using SQL whitelists and/or blacklists and other mechanisms), normal exception handling is automatically restored.

### General Implementation of the Security Extensions

The SP technologies are implementation-agnostic across many RISC ISAs. The narrow tags and in-line metadata tags facilitate this. Extending tag storage to instruction and data caches facilitate the performance scaling, along with use of known techniques for mitigating the overhead of tag accesses. It is worth noting that the SP system, as described herein, does not use all of the 256 tag values that are possible with 8-bit word tags. This permits other tag values to be used in ways that can evolve as the SP design matures during or beyond the project, and other extensions consistent with the SP architecture or independent of it.

The access control policies used for protection domains in SP are also very flexible, as the access control code can be implemented in software within trusted handlers that can be invoked quickly as a local handler. Thus, SP's security architecture provides flexibility in the design and use of tags, as well as in crafting a variety of security policies.

In the SP, the code associated with protection domains is designed to support multithreading and SMP (multicore) implementations. Utilities for SP are also designed to be thread-safe. Cross-domain parameter passing registers, bounds, special registers containing a local handler address(es), and tags associated with general-purpose registers in the ISA, have to be all part of the context of a process/thread and need to be saved on context switches. Extending the tags to the instruction and data caches permit exiting cache coherence mechanisms to be easily used for SP for multicore implementations with cache coherence logic.

For CISC ISAs like the x86, variable-length instructions do impose an addressing challenge for the instruction tags in separate pages from the code. The solution to be used for incorporating the SP security mechanism for detecting software vulnerability exploits relies on instructions being non-writable, and stores instructions adjacent to their tags, and the instruction decoder is modified to take the (uniform-sized) instruction tags into account. The compiler also takes into account the tag size for generating the offsets used in PC-relative addressing.

It is also possible to use 4-bit encoded tags for SP, which makes it easy to pad memory lines containing instruction tags and simplify instruction tag addressing. There are many specific optimizations that can reduce the performance overhead of a x86 CPU including the SP security mechanisms, compared to the baseline traditional implementation.

For example, micro-op (uop) trace caches used in many x86 implementations, which contain validated traces and security checks (and associated performance delays and power dissipations), can be avoided when the trace is re-executed and other performance boosting artifacts built around trace caches (such as group commitment) can be used.

### SUMMARY OF THE INVENTION

The processor architecture according to the present technology realizes a practical system for ensuring the integrity of control flow and pointers by reducing performance, hardware and power overhead and yet provides a wide range of hardware-supported security mechanisms. The present technology provides a Secure (Tagged) Processor (SP) that strikes a balance between performance and richness of tag-based security functions in order to provide protection against control flow attacks in a practical manner.

One aspect of the technology focuses on control flow and pointer integrity applications, the basic tagging scheme of SP can be adapted to encode various security-sensitive policies such as code checksum, statically determinable runtime invariants (e.g., last read/write of a variable) that target different threat models.

SP leverages the compiler as a rich source of information for providing the integrity of control flow as well as the integrity of data and code pointers in a general manner. Rich program semantics (e.g., pointer types) that are typically lost during compilation are captured by the SP compiler and persisted into the binary in the form of instruction and data tags. These tags are processed and checked in the hardware to enforce the integrity of control flow, data pointers and code pointers to address vulnerabilities that stem from the inherent flaws in the software.

The present technology, according to one embodiment, presents a hardware-based solution, which generalizes the use of narrow, directly-interpretable instruction tags and their use with data tags, in order to enforce control flow integrity and the integrity of code and data pointers. This may be achieved by enforcing legal, context dependent behavior of instructions.

An instruction tagging scheme, called inline tagging, may be provided to eliminate the need for an additional cache for instruction tags, to co-access an instruction along with its associated instruction tag and thus maintain the locality of reference in accessing instructions.

A prototype includes a full stack implementation with hardware, its compiler and OS support, along with the security policies tied to the instruction and data tags.

### Threat Model and Assumptions

In general, an application may contain one or more software vulnerabilities that adversaries can exploit to launch a wide variety of attacks including control flow attacks. Specifically, these vulnerabilities can let an attacker gain control of the program stack to rewrite return addresses, code/function pointers, initiate buffer overflow attacks and bypass ASLR-protected memory using knowledge of the memory layout of the program. The technology is compatible with Data Execution Prevention (DEP) in the hardware. However, the code along with tags introduced by SP cannot be modified by the attacker.

Vulnerabilities may be limited to user-space, encompassing user applications and libraries. However, the solution can also be extended to all software in a system, including the kernel.

The hardware platform may enforce protection against code injection (e.g., NX-Bit).

The kernel, compiler, linker and loader may be presumed to be trusted components.

Orthogonal defenses such as ASLR may complement and strengthen the protections offered by SP.

The foundational pillars of the SP security framework are:
1) Control transfers only take place between instructions specified in the software. These include function calls, jumps, branches and their respective targets.
2) Control flow targets are reached by the specific types of control transfer instructions designated for them. For example, function return instructions only transfer control to instructions identified as return targets.
3) All indirect control transfer instructions use valid code pointers.
4) Return addresses stored in memory are tamper-evident and cannot be used for control transfer if their integrity is violated.
5) Return addresses are created only by executing a function call instruction and cannot be forged by any other means.
6) Malicious overwrites to pointers (code & data) by nonpointer data, to code pointers by data pointers and vice versa are detected at the time of misuse.
7) Memory addresses used by load and store instructions are always valid data pointers.
8) Instructions not intended by the compiler to involve pointers cannot use, modify, or generate pointers.

Assurances 1 and 2 are provided by points-to analysis performed by the compiler in conjunction with instruction tags. Data type analysis along with instruction and data tags are used to provide Assurances 3 through 8. For the Assurance 6, the detection is delayed until the corrupted pointer is used to initiate an exploit. However, unlike silent errors where the source of the error is often unknown, because the precise violation is known during policy enforcement, the instruction that resulted in invalidation of the pointer can be identified, thereby aiding in diagnosis and triage efforts.

### Control Flow Attacks and Software-Centric Solutions

Widely used hardware and software-based defenses against control flow attacks include Data Execution Prevention (DEP) [6], Address-space layout randomization (ASLR) [49]. However, these mechanisms are not adequate—for example, code reuse attacks can be launched even in the presence of DEP [61].

Matching the labels preceding a control transfer instruction with a counterpart at the legal target of the control flow has been one of the earliest software defenses against CFI attacks, as pioneered by Abadi [3], [4]. Traditionally, such label matching has been implemented in a variety of ways, including software-only mechanisms (compiler-based) [8], binary rewriting [67], virtual-machine based [68], and hardware assisted mechanisms. Usually, runtime checks are added to ensure that all function calls, jumps and returns are directed to valid locations that have been pre-determined prior to execution. The security and performance of these schemes depend on their implementations. Techniques that tag all the call sites with unique IDs as labels by analyzing all possible jumps are called fine-grained; these provide better security as they narrow down the possible control flow transfers. Unfortunately, such fine-grained techniques can have a performance overhead of 100% or more, as seen for stack protection and other application scenarios [60], making them impractical. Coarse-grained solutions using control flow labels have lower performance overhead but offer weaker protection [40], [67], [68], and are vulnerable to attacks [12], [21], [29], [30].

In general, memory corruption can trigger control flow attacks. Protecting pointers on stack is not new and has been explored in many different ways. Low-overhead software-only stack protection schemes such as StackGuard and shadow stacks protect return addresses, but cannot protect other control flow structures. This makes them vulnerable to attacks that leak information and do direct writes to the memory. The overhead of software-implemented shadow stack mechanisms can be substantial [17]. Low-overhead memory safety techniques implemented in software have been proposed for code pointers [37]. However, broad-based, practical solutions for CFI and pointer integrity remain clusive.

### Hardware-Centric Solutions

A plethora of hardware-assisted mechanisms have been proposed to overcome the performance overhead of software CFI and pointer integrity assurance techniques [15], [18]-[20], [22], [28], [31], [33], [35], [36], [38], [45], [46], [50], [56], [58], [66]. Hardware schemes include using shadow stacks to protect sensitive data [33], [48], tracing the control flow graph (CFG) of the program at runtime [5], [28], [31], [35], [36], [62], and using tagged architecture [11], [23], [24], [26], [51], [56], [64]. With addition of dedicated register files, the use of an additional label cache and hardware-supported label matching, the performance overhead of CFI can be reduced dramatically compared to software solutions. Hence, hardware support for shadow stacks have been proposed in [33], [48]. Although hardware stack protection is faster, providing memory safety for the full application is extremely expensive [42].

The use of tagged memory is an attractive choice for providing safety for pointers. The idea behind tagged memory is to extend each memory word with additional tag bits to protect against pointer (or data) corruption. Recent tag-based hardware systems and other recent mechanisms for CFI and pointer integrity are summarized and compared in Table 6. CHERI [63], uses capability-based addressing in hardware to avoid illegal memory corruption and unintended information leakage. Capabilities are distinguished from other memory entities using a 1-bit tag. CHERI requires significant changes in the software layers and protected calls securing module boundaries have a significant performance overhead [34], making it impractical for fine-grained protection.

PUMP and variants [24], [26], [27], use word sized metadata tags with individual instructions and data items, significantly increasing storage needs. The added need to look up a two-level PUMP cache using a wide key formed with the metadata tags and other information before any security micro-operations can be started introduces performance bottlenecks that can translate to a slower clock speed. Together, these drawbacks discourage any practical deployment. PUMP reports up to a 400% performance overhead using a simulator and is therefore not a real full stack implementation like SP. We note that DOVER is a PUMP-derivative hardware implementation and is susceptible to similar performance bottlenecks as PUMP. See, U.S. 2017/0177368.

Data-only tagging as used in Hardware-Assisted Dataflow Isolation (HDFI) has limitations in providing CFI, since non-control flow data can still be exploited to mount control flow attacks [32]. HDFI implements only one specific security mechanism at a time, while SP supports a comprehensive set of CFI and pointer integrity checks. LowRISC provides two bits of tagging in its memory system that could be used to implement a variety of memory safety mechanisms. ZERØ is a pointer integrity mechanism that prevents corruption of code and data pointers in memory and relies on the use of new instructions for loading and storing these pointers. No protection is provided against illegal function or code pointer use by instructions, such as use of illegal indexing or use of illegal instructions that perform arithmetic and/or logical operations on these pointers and then use the modified pointers. In contrast, SP uses instruction tags to ensure that pointers are accessed, modified and used only by instructions that are deemed legitimate by the compiler.

Enforcement of the context-specific behavior of existing instructions in an ISA can address many security vulnerabilities in software. The SP architecture presented in this paper does so by using narrow instruction and data tags, with instruction tags embedded in the binary and co-located with corresponding instructions within a cache line, to realize a practically viable design. A set of instruction and data tags and their associated hardware-implemented security policies were proposed for SP to mitigate control flow and pointer integrity attacks. A proof-of-principle hardware-software prototype of SP was implemented on a Xilinx FPGA and appropriate supporting functions were incorporated within a modified Linux OS and a modified LLVM compiler. The performance, power and hardware overhead of the resulting system compared to an untagged baseline design are in the low single digit percentages; this improves the viability of deploying the system. SP's tagging scheme goes well beyond the enforcement of control flow and pointer integrity.

Instruction tagging, by itself, can implement other security functions without the use of data tagging and even the use of a single-bit data tag. Instruction tagging can also support applications beyond security, such as event-triggered code instrumentation, debugging and many others.

The present technology provides a microprocessor having specific hardware support for detection of common types of software vulnerabilities or weaknesses that lead to security violations in a computing system.

This technology may be implemented as a hardware improvement that can be incorporated into an existing processor type, called a “Secure Processor” (SP) to detect exploitations of software vulnerabilities in the software, either accidentally or maliciously by compromised programs. The mechanisms employed are largely portable across different instruction sets, and are therefore not limited to any particular type of microprocessor architecture. The implementation may also be in a Complex Programmable Logic Device (CPLD), which has code-implemented hardware architecture, or in a software emulation. Typically, software implemented or software-assisted implementations are not preferred unless the computer or server on which they are implemented is physically secure, and the system is hardened against overflow and collateral attacks.

The security mechanism adds tags to each instruction and data word, leading to a tagged processor design for the SP. The added tag bits are used to enforce specific usage of instructions and data in the SP. The tags may be uniform in size (8-bits), or variable in size. The SP associates relatively narrow word-tags with every memory word that contains data or an instruction, to detect the exploitation of a number of software vulnerabilities.

The SP improves on existing security-tagged architectures is its pervasive use of these tags, to not only enforce the data type compliance rules of the application, but to also enforce context-specific legal uses of both data and instructions associated with control transfer, secured/bounded pointers, potentially-tainted data from an input device, and in other critical scenarios. The tags are preferably generated during compilation, though in some cases, tags may be dependent on platform/runtime considerations. The compiler may determine possible tag-induced inefficiencies, and structure the object code optimally with respect to issues such as mass storage system (e.g., SSD) operation, interaction with software code that presumes explicit 32 or 64 bit boundaries for words, peripheral devices that do not support a full 40 or 80 bit data or instruction width, and the like.

The SP may include additional secure features, such as word-sized, in-line metadata tags that specify access control information, which complement the word tags, which help form a basis of protection domains. That is, as an additional feature, the compiler may insert SP-specific codes, called metadata because they are not executable code or their corresponding data, that are executed by SP extensions to the normal ALU processor. In other cases, the metadata tags may be executed by the ALU itself, with results used as control or feedback to the SP extensions of the SP processor.

Protection domains are hardware-implemented security compartments that encapsulate externally-callable and private functions, private data and can be set up to a security compartment that encompasses a single address space or set up multiple protection domains within a single address space. This permits a single application or a system component (like the OS) to be compartmentalized. The callable functions within a domain are invoked through word-tag enforced legal call gates, and every invocation uses existing control transfer primitives tagged appropriately for context-specific use. Such calls perform an access control check which can further enforce the principle of least privileges and/or other access control policies.

To secure a fenced, contiguous region of data, word tags may be used to ensure that accesses are possible with secured pointers, with automatic bounds checking on each access. The SP's security mechanisms may also include CPU-internal per-thread key registers and memory encryption engines, which together with protection domains provide information containment and isolation. In many instances, the SP uses multiple layers of protection to provide a robust solution against the software vulnerabilities.

In SP, the enforcement of proper context-specific use of many existing instructions (that are related to control flow or to accesses performed to a secured memory region with bounds enforcement) is specifically targeted with word tags for instructions to avoid the addition of new instructions that lead to an ISA bloat.

The security mechanism adds interspersed tags to each instruction and data word, leading to a tagged processor design for the SP. The added tag bits are used to enforce specific usage of instructions and data in the SP. The SP associates relatively narrow word-tags with every memory word that contains data or an instruction, to detect the exploitation of a number of software vulnerabilities. Preferably, the tags are adjacent to the associated instruction or datum, and are automatically retrieved in the same process without address translation or secondary retrieval operations. For example, a cache may be associated with a 64-bit processor, and include facilities for 8 bits for each double word (D-word), i.e., 72 bits wide for each double word (D-word). The availability of 8 tag bits does not mean that all such tag bits are used in every case. For example, instructions may have 8-bit tags, and data may have 2-bit tags. The bus width of the cache is therefore 80 bits wide, permitting words and tags to be stored and retrieved together. The tags are advantageously stored together with the main memory together with the instructions or data. The memory may advantageously ECC memory, with the additional bits repurposed for tags.

### OBJECTS OF THE INVENTION

It is therefore an object to provide a microprocessor, comprising: a logic unit configured to receive and execute instructions optionally dependent on data, each instruction having an associated instruction tag containing information to enforce predefined context-dependent behavior, and each datum having an associated datum tag containing information indicating limitations on behavior of the logic unit with respect to the datum; and a memory configured to securely store the instruction tag to prevent or flag changes to the instruction tag and the associated instruction prior to communication to the logic unit, the logic unit preventing execution of an instruction unless the instruction is valid and associated with a valid tag, wherein at least one instruction tag specifies a plurality of operation requirements for the instruction.

It is also an object to provide a processor where an instruction tag is associated with a specific instruction and where the tag contains information to enforce specific context-dependent behavior intended for the instruction by the programmer or the compiler and where the tag is stored securely and not modifiable once it is generated and during program execution, and where the information within the tag can be directly interpreted by the hardware to enforce the intended behavior of the associated instruction during execution and wherein a single instruction tag can specify one or a plurality of operation requirements for the instruction.

The processor may be augmented with data tags associated with the operands of an instruction in registers or memory locations wherein each of the data tag contain information that prevent unintended operations to be done with and on the operand and where the data tags are stored securely and only modifiable by the processor hardware during program execution based on the tag associated with an instruction, thereby permitting context-specific intended processing to be enforced using instruction tags in conjunction with the data tag of one or a plurality of operands for the instruction.

The Processor may be augmented with the ability to write the contents of a processor register and its associated data tag into the memory when such an operation is allowed by the information specified within the instruction tag associated with the instruction performing the write and in conjunction with the data tag associated with the memory location that is written to by the instruction and wherein the tags associated with memory location remain protected and modifiable only by the processor hardware during program execution based on the tag associated with an instruction.

The Processor may be augmented with the ability to read the contents and the data tag associated with a memory location into one or a plurality of processor registers when such an operation is allowed by the information within the instruction tag associated with the instruction performing the write and in conjunction with the data tag associated with the memory location that is written to by the instruction and wherein a single instruction tag can specify one or a plurality of operation requirements for the instruction.

An embodiment provides instruction tags specifying security operations for individual instructions placed in uniform-sized fields with said fields located at regular intervals within the executable code for a program, with a plurality of instruction tags held within each field that applies with a one-to-one correspondence to a plurality of instructions in the executable code that are adjacent to the field containing instruction tags, with the size of each field containing instruction tags and the placement intervals of said field of instruction tags within the executable code being known to the processor hardware.

Another embodiment provides instruction tags specifying security operations for individual instructions placed in uniform-sized fields with said fields located at regular intervals within the executable code for a program, with a plurality of instruction tags within each field that applies with a one-to-one correspondence to a plurality of instructions in the executable code that are adjacent to the field containing instruction tags, with the size of each field containing instruction tags and the placement intervals of said field of instruction tags within the executable code being known to the processor hardware.

A further embodiment provides the fields containing instruction tags embedded at regular intervals within the executable code appear at least once within a single cache line within the instruction cache closest to the processor.

Another embodiment provides that the fields containing instruction tags that are embedded at regular intervals within the executable code appear at least once within a single cache line within the instruction cache closest to the processor.

A further embodiment provides instruction tags for the binaries held in a separate protected memory area and where the cache line with the cache containing instructions at a level closet to the processor has an extension that holds the instruction tags associated with the instructions within the cache line.

An embodiment provides instruction tags for the binaries held in a separate protected memory area and where the cache line with the cache containing instructions at a level closet to the processor has an extension that holds the instruction tags associated with the instructions within the cache line.

Another embodiment provides instruction tags specifying security operations for individual instructions placed in fields whose size can vary and placed within the executable code for a program, with a plurality of instruction tags within each field that applies with a one-to-one correspondence to a plurality of instructions in the executable code that are adjacent to the field of instruction tags and where each field containing instruction tags have information that indicates the size of the tag field and how the instruction tags therein correspond one-on-one to instructions adjacent to the field of instruction tags.

A further embodiment provides instruction tags specifying security operations for individual instructions placed in fields whose size can vary and placed within the executable code for a program, with a plurality of instruction tags within each field that applies with a one-to-one correspondence to a plurality of instructions in the executable code that are adjacent to the field of instruction tags and where each field containing instruction tags have information that indicates the size of the tag field and how the instruction tags therein correspond one-on-one to instructions adjacent to the field of instruction tags.

Another embodiment provides information contained in the instruction tag associated with an instruction, along with the information data tags associated with operands of the instruction, together determine whether the instruction is able to complete successfully.

An embodiment provides that information contained in the instruction tag associated with an instruction, along with the information contained within the data tags associated with a memory location targeted for use by the instruction, together determine whether the instruction is able to complete successfully.

An embodiment provides that information contained in the instruction tag associated with an instruction, along with the information contained within the data tag associated with a memory location targeted for modification by the instruction, together determine whether the instruction is able to complete successfully.

An embodiment provides an instruction tag associated with an instruction contains information that is used to check if the address of the memory location accessed by the instruction falls within a range of data memory addresses maintained in special registers identified by the instruction tag and wherein data tags associated with each memory location within the range of memory addresses allows a memory access by the instruction only on passing the check and where the data tags of the memory location prevents it from being accessed by any instruction that does not have an associated instruction tag to enforce the check.

An embodiment provides an instruction tag associated with an instruction contains information that is used to check if the address of the memory location accessed by the instruction falls within a range of data memory addresses maintained in special registers identified by the instruction tag and wherein data tags associated with each memory location within the range of memory addresses allows a memory access by the instruction only on passing the check and where the data tags of the memory location prevents it from being accessed by any instruction that does not have an associated instruction tag to enforce the check.

An embodiment provides that the tag associated with an instruction allows the instruction to update data tag of the operand modified by the instruction, to indicate that the final access on the operand has been completed.

An embodiment provides that the tag associated with an instruction specifies if it is allowed to perform operations or use a pointer to code memory.

An embodiment provides that the tag associated with an instruction specifies if it is allowed to perform operations or use a pointer to data memory.

An embodiment provides that the tag associated with an instruction performing a data retrieval for use specifies that the memory location's data tag be set to a prespecified value after the memory read has been completed.

An embodiment provides that the tag associated with an instruction specifies whether it can be the destination of a control flow instruction of a specific type and wherein any control transfer by the specific control flow instruction type is allowed only to instructions tagged as a target of that specific control flow instruction type.

An embodiment provides that a control flow label immediately preceding a control flow instruction within the binary representation of the code has a control flow destination containing a similar label as its target, immediately preceding the intended instruction of the control flow instruction's target and where control flow is permitted only when the labels match and where the label themselves are treated as operations that do not affect data memory or register contents.

An embodiment provides security compartments for data, and that the data tag of a memory location specifies the security class of the data, and a data is only allowed to be retrieved if the security class of the instruction has higher or equal security class compared to the security class of the data.

According to one implementation, the SP implements two types of protection domains, fully-isolated and lightweight domains relying on instruction tagging to implement secure call gates and using sealed pointers to implement cross-domain calls with access checks on entry. Word tags are also used as labels to enforce context-specific usage of exiting instructions for cross-domain calls. The approach taken has some similarity with earlier work on capability extensions for a RISC pipeline. The SP's protection domains can be used within the applications or the systems software components, specifically within the OS, libraries and utilities. The SP's fencing mechanism for limiting accesses with bounds checking to a fenced memory region uses a capability-like secure region pointer that specifies the region's address and size and the privilege level with which the region is accessed using instructions at all privilege levels as long as they have the secured pointers.

It is therefore an object to provide a microprocessor, comprising: a memory configured to securely store an instruction tag and to prevent or flag changes to the instruction tag and the associated instruction stored in the memory; and a logic unit configured to: (i) receive and execute a series of instructions optionally dependent on data, each instruction having an associated instruction tag from the memory containing information to enforce predefined context-dependent behavior, and each datum having an associated datum tag containing information indicating limitations on behavior of the logic unit with respect to the datum, the logic unit being responsive to at least one instruction tag which specifies a plurality of operation requirements for the associated instruction; and (ii) prevent execution of an instruction unless the instruction is associated with a valid instruction tag authorizing execution.

The datum tags may contain information that prevent unintended operations relating to the respective operands or processor registers by the hardware instruction processor and hardware tag processor, are stored securely and only modifiable by the hardware instruction processor or hardware tag processor, based on the specific instruction tag associated with the specific instruction, and permit context-specific processing to be enforced using the specific instruction tag in conjunction with the data tags of the respective operands or processor registers.

A further object provides a secure microprocessor, comprising: a communication port configured to receive instructions and corresponding instruction tags from external to the secure microprocessor; a cache configured to receive the instructions and instruction tags through the communication port, comprising a cache line having (i) memory locations for storing instructions, and (ii) memory locations for storing instruction tags accompanying each respective instruction; a control transfer processing unit, configured to enforce control transfer restrictions based on at least a validity of instructions comprising a control flow instruction defining at least an entry point of each control transfer, selectively dependent on respective accompanying instruction tags for each respective instruction from the cache line; a logic execution unit configured to process data based on the instructions and interacting with the control transfer processing unit dependent on the control transfer restrictions; and a tag processing unit, configured to: process the instruction tags having instruction execution restrictions; enforce the instruction execution restrictions with respect to execution of the instructions from the cache line, access to resources, manipulation of data, and interaction with the control transfer processing unit to enforce control transfer restrictions; and concurrently interact with the logic execution unit dependent on the instruction execution restrictions.

It is another object to provide a secure processing method, comprising: providing a memory storing instructions and instruction tags, the instruction tags being stored securely and unmodifiably after generation and during program execution; retrieving the stored instructions and instruction tags into a memory location; fetching a specific instruction from the memory location into a hardware instruction processor concurrently with fetching a specific instruction tag associated with the specific instruction into a hardware tag processor, wherein the specific instruction tag contains information to enforce specific context-dependent behavior for the specific instruction; and processing the specific instruction concurrently with processing the associated specific instruction tag, wherein absent a security exception, the processing of the specific instruction tag associated with the specific instruction is completed without stalling at or before a time of completion of the processing of the specific instruction, wherein the specific instruction tag is directly interpretable to enforce the specific context-dependent behavior of the associated specific instruction during execution, and the specific instruction tag specifies at least one operation requirement for the associated specific instruction.

The hardware instruction processor may receive a data tag augmenting a respective operand of the specific instruction or contents of a processor register, and the data tag: may contain information that prevents unintended operations relating to the respective operand or contents of the processor register, be stored securely and only modifiable by the hardware instruction processor or hardware tag processor, based on the specific instruction tag associated with the specific instruction, and permit context-specific processing to be enforced using the specific instruction tag in conjunction with the data tag of the respective operand or contents of the processor register. The processing method may further comprise writing the contents of the processor register and the data tag associated with the contents of the processor register into the memory location, when allowed by the specific instruction tag associated with the specific instruction performing the write, and allowed by a data tag associated with the memory location, and wherein the data tag associated with the memory location is protected from unauthorized access and modification.

The specific instruction may be a transfer instruction, further comprising executing the transfer instruction to read data from a first memory location and the data tag associated with the first memory location into the processor register, and writing the data to a second memory location, selectively dependent on the specific instruction tag associated with at least the associated specific instruction comprising the transfer instruction and a data tag associated with the second memory.

The hardware instruction processor may receive data tags augmenting operands of the specific instruction or contents of at least one processor register, wherein the data tags: contain information that prevent unintended operations relating to the respective operands or processor registers by the hardware instruction processor and hardware tag processor, are stored securely and only modifiable by the hardware instruction processor or hardware tag processor, based on the specific instruction tag associated with the specific instruction, and permit context-specific processing to be enforced using the specific instruction tag in conjunction with the data tags of the respective operands or processor registers.

The memory may store code for an executable program, and the instruction tags have a uniform size, and are regularly interspersed with the instructions of the code in the memory.

The memory may store a sequence of instructions alternating with instruction tags for an executable program.

The memory may store a plurality of instructions in first fields and a corresponding plurality of instruction tags in second fields, the first fields and second fields being adjacent within the memory, wherein a size of and a placement interval of each first field and second field within the executable code is predetermined.

The memory may comprise a level-one cache memory, wherein a single cache line containing the instruction also contains the specific instruction tag associated with the specific instruction. The single cache line may have a first set of dedicated fields for storing a plurality of instructions and a second set of dedicated fields for storing a plurality of instruction tags, and wherein the first set of dedicated fields are directly read by the hardware instruction processor and the second set of dedicated fields are read by the hardware tag processor. The single cache line may have a first dedicated field for the specific instruction and a second dedicated field for the specific instruction tag, and wherein the first dedicated field is directly read by the hardware instruction processor and the second dedicated field is directly read by the hardware tag processor. The memory may store executable code of a program organized as instructions interspersed with instruction tags are regular intervals, further comprising retrieving a program segment into the cache while aligning the specific instruction with the first dedicated field and the specific instruction tag with the second dedicated field.

The instruction tags specifying security operations for individual instructions may be placed in variable-sized tag fields and placed within the executable code for a program, with a plurality of instruction tags within each variable-sized tag field that applies with a one-to-one correspondence to a plurality of instructions in the executable code that are adjacent to the field of instruction tags and wherein each variable-sized tag field containing instruction tags has information that indicates a size of the respective variable-sized tag field and how the instruction tags therein correspond one-on-one to instructions adjacent to the field of instruction tags.

The instruction tags may be variable size instruction tags, and located adjacent to a corresponding instruction in a field of a program code binary, wherein each field containing an instruction tag has information that indicates a size of the adjacent variable size instruction tag and how the variable size instruction tag therein corresponds to the instruction.

Whether the instruction is able to complete successfully may be determined together by information contained in the instruction tag associated with the specific instruction, along with data tags associated with at least one of (i) operands of the respective instruction, (ii) a memory location targeted for use by the respective instruction, and (iii) a memory location targeted for modification by the respective instruction.

The specific instruction tag associated with the specific instruction may contain information that is used to check if an address of a memory location accessed by the specific instruction falls within a range of data memory addresses maintained in special registers identified by the specific instruction tag.

The specific instruction tag associated with the specific instruction may specify if the specific instruction is allowed to at least one of: (i) perform an operation on a field holding an instruction, (ii) use a pointer to instructions maintained in memory; (iii) perform an operation on a field holding data, (iv) use a pointer to data maintained in memory, (v) perform a memory read of a memory location for use of retrieved data specifies that the memory location's data tag be set to a prespecified value after the memory read has been completed, (vi) be a destination of a control flow instruction of a specific type, and (vii) update a data tag of an operand modified by the specific instruction, to indicate that the final access on the operand has been completed.

It is also an object to provide a secure processor, comprising: a logic execution unit configured to process data based on instructions; a communication interface unit, configured to transfer the instructions and accompanying instruction tags, and the data and accompanying data tags; a tag processing unit, configured to enforce specific restrictions with respect to at least execution of instructions and use of data, and optionally access to resources, selectively dependent on the tags; and a control transfer processing unit, configured to validate a control transfer initiation and entry point of each control transfer, selectively dependent on the respective accompanying tags.

It is also an object to provide a secure processing method, comprising: transferring instructions and accompanying instruction tags, and data and accompanying data tags; enforcing, by a tag processing unit, specific restrictions with respect to at least execution of instructions, use of data, and optionally access to resources by an execution unit, selectively dependent on the accompanying tags; and validating a control transfer initiation and entry point of each control transfer, selectively dependent on the respective accompanying tags, with a control transfer processing unit.

The tag processing unit may be implemented in hardware.

The tag processing unit may be further configured to ensure compliance with data type rules; memory access rules; context-specific data usage rules; source-dependent data usage rules; data modification rules; source-dependent instruction execution rules; context-dependent instruction execution rules; instruction sequence modification rules; control transfer instruction rules; and/or metadata tag modification rules.

The tag processing unit may be configured to enforce a restriction on use of data as an address within a memory space; data as a return address for a subroutine call; data as a target address of an indirect branch; data as a pointer; an instruction to control flow to a legal path; an instruction to call a function; an instruction to return from a function call; an instruction to access a protected domain or module; an instruction to perform a legal operation based on the source data type; and/or an instruction to bound access to a fenced memory region.

The communication interface unit may be configured to concurrently or sequentially transfer a respective instruction or data, and a respective accompanying tag.

The logic execution unit may be a RISC or CISC processor or portion thereof, with word length 8, 16, 32, or 64 bits, for example.

The tags may be narrow tags, e.g., 2-bits (e.g., data tags), 4-bits, 8-bits (e.g., instruction tags), or 16-bits for example. In some cases, the processor supports metadata tags which occupy a full word size, and control operation of the tag processing unit through a communication between an instruction processing unit and the tag processing unit. These metadata tags therefore provide an in-line method of providing control where the narrow tags are insufficient, and also provide a facility for tagging groups of instructions or data, or both.

The tag may comprise a privilege level which restricts access by the logic execution unit under control of instructions having the privilege level to the tags. The may tag comprise a second privilege level which permits access by the logic execution unit under control of instructions having the second privilege level to the tags.

At least one tag may indicate tainted instructions or data, wherein the tag processing unit requires validation of the tainted instructions or data prior to use. The validation may be performed during execution of the tainted instructions or data, or within a separate context, in which case after a successful validation, the tainted instruction or data tag is modified to permit execution, or a metadata tag provided to authorize and/or supervise execution.

The secure processor may further comprise a cryptographic unit, configured to perform cryptographic operations on information communicated through the communication interface unit. The cryptographic unit may employ distinct cryptographic keys selectively dependent on the tags. The cryptographic unit may employ distinct cryptographic keys selectively dependent on a respective thread of instruction execution.

The secure processor may further comprise an address translation unit, configured to map logical memory spaces to physical memory pages. The address translation unit may be further configured to maintain separate memory pages of instructions and data, or instructions, data and tags. In the later case, the tags may be interspersed with the instructions and data during retrieval so that they reside together within the processor cache. In the later case, the address translation unit may be further configured to retrieve memory pages of tags together with associated memory pages of instructions and/or data for interspersed storage in a common cache. The tags are preferably a per instruction or per word tag, and therefore the instructions or data, and corresponding tags, may be communicated concurrently through an expanded bus, i.e., having a width greater or equal to the instruction/data plus tag width. Advantageously, error correcting (ECC) memory style system components may be employed, with the extra bits allocated to tags instead of parity information.

The address translation unit may be further configured to maintain a privilege restriction on memory pages of instructions and tags, and data and tags, which restricts reading, writing, and execution, unless accessed by trusted hardware or according to instructions having associated tags which indicate higher privileges. The memory pages of tags may be subject to an integrity check by the secure processor prior to execution of instructions from the memory pages of instructions.

A set of instructions comprising a code segment may be accompanied by a metadata tag, comprising at least one of a security level or a privilege level of the code segment, wherein the tag processing unit may be further configured to compare the security level or the privilege level of the code segment with a security level or a privilege level indicated by the respective tag of a calling instruction of the code segment. The metadata tag may occupy the normal instruction locations, and be communicated to the tag processing unit either by recognition of the metadata tag as being distinct from a normally executable instruction, or by a tag occupying the tag bits which identify the metadata tag as being an exception to normal execution.

It is noted that in contrast to normal tag execution, which typically does not stall the execution pipeline, and may provide useful outcome permissions within the execution time for a normal complexity instruction, the metadata tag may incur excess latency or latencies, though the metadata tag itself provides a “hole” or gap in the execution pipeline, and therefore may not necessarily incur greater latencies than execution of a normal complexity instruction might incur.

The logic execution unit may have a logic execution pipeline with a first number of stages, and the tag processing unit has a tag processing pipeline with a second number of stages, the first number being greater than or equal to the second number, and the instruction processing rate is not retarded by normal tag processing (of tags indicating valid and authorized instructions).

The tag processing pipeline may have a tag processing stage which relies on information provided by at least one stage of the logic execution (instruction processing) pipeline.

The logic execution (instruction processing) pipeline may selectively process instructions in dependence on signal generated by stages of the tag processing pipeline.

The tag processing unit may comprise a tag processing pipeline, and the logic execution units comprises a logic execution pipeline, the tag processing pipeline and logic execution pipeline having synchronized operation, wherein the tag processing pipeline relies on information received the logic execution pipeline pertaining to the instructions it processes, sent from a stage in the logic execution pipeline to a corresponding stage in the tag processing pipeline, and the tag processing pipeline having at least one stage configured to generate signals that affect the behavior of the logic execution pipeline.

The secure processor may further comprise an instruction cache having cache lines, each cache line comprising memory locations for storing instructions and adjacent memory locations for storing tags, wherein the secure processor is configured to retrieve instructions and adjacent tags based on the instruction addresses.

The communication interface unit may be configured to retrieve an instruction or data and associated tag based on an instruction or data address, and to retrieve a tag corresponding to the instruction based on the instruction or data address. This facilitates execution of standard code, since the address or location of the tags is implied by the location of the instructions or data. As noted above, the tags will typically be stored in adjacent memory locations with the instructions or data, and the storage and retrieval effected through an expanded bus and memory channel. In the case of components that do not provide or support the expanded bus width, a hardware or software system may be provided for translation of the data or instructions and their associated tags. This translation may be transparent to the executable code.

The communication interface unit may be configured to: retrieve information from a memory according to an address, store the retrieved information in a cache, and to perform a confinement check to determine whether the address is within a predefined memory region, and selectively access a tag in dependence on whether the address is within the predefined memory region.

The predefined memory region may comprise a fenced memory region demarcating by a set of guard memory words defining a starting address of a string of memory locations containing the information to be retrieved. The fenced memory region may contain information that does not need to be protected and tagged as unmodifiable.

### BRIEF DESCRIPTION OF THE DRAWINGS

FIG. 1 shows a cache line showing a tag container for In-lined Instruction Tags

FIG. 2 shows instruction tag access in a 2-way Instruction Cache (I-Cache) for In-lined Instruction Tags

### DETAILED DESCRIPTION OF THE PREFERRED EMBODIMENTS

### Example 1

According to a first embodiment, each instruction and datum is associated with a tag, and are retrieved into the processor cache interspersed. For example, a cache line of the cache has hardware for retrieving tags from certain locations (e.g., columns) in the cache directly into the tag processing unit. Some columns may be dual purpose, to maintain efficiency in view of variable length data and instructions. On the other hand, the cache columns may be dedicated for tags on one hand and instructions or data on the other. Long instructions, for example, may be interrupted with tags or portions of tags, preserving the dedicated columns in the cache.

In main memory, the tags are preferably also interspersed with the program and data file, though in some cases may be stored separately.

One aspect of this architecture is that it may exploit certain memory architectures such as error correction code memory, which supplies extra bits. In this case, instead of using these extra bits for error correction codes, they may be allocated to tags, facilitating storage and retrieval of the tags along with the associated data or instructions.

In some cases, processing components other than the central processing unit may read and process the tags and their associated data or instructions, such as the graphics processing unit, memory management unit, or the like. Therefore, storage of the tags in-line with the data or instructions relieves the system of having to manage the tags separately.

### Example 2

A second embodiment of the technology is implemented as follows. Note that this implementation is not universal for the scope of the invention, and it is exemplary of how the technology can be employed.

### Data Tags

SP tags each machine-word (32 bits aligned at 32-bit boundary) in memory with one of the 2-bit data tag values listed in Table 1. The data tags are symbolically represented using two capital letters surrounded by square brackets. Data tags enable code pointers, data pointers, and return addresses to be distinguished from one another and from other nonpointer data not only in memory but in registers as well. Data tags propagate from memory to register, register to memory, and register to register in accordance with the SP security policies. Relevant data tags for this invention are symbolically shown in TABLE 1.

TABLE 1
Data Tags

| Tag | Description |
|---|---|
| [DT] | Non-Pointer Data |
| [DP] | Data Pointer |
| [CP] | Code Pointer |
| [RA] | Return Address |

### Instruction Tags

SP enforces legal, context dependent behavior of instructions through instruction tags. Each 32-bit instruction is associated with a 6-bit tag. An instruction's tag, in combination with the instruction's opcode, informs the hardware of the instruction's semantic context, and consequently the security policies to enforce.

The instruction tags used in SP are presented in Table 2. The instruction tags are symbolically represented using three capital letters surrounded by square brackets. For showing the various possible instructions that can be associated with a particular tag value in a compact manner in Table 2, instructions are grouped into three categories. These categories are: control transfer instructions (function calls, function returns, indirect jumps, branches), memory instructions (load and store) and arithmetic instructions (addition, bit shifting, logical operations). In practice, the exact effect of an instruction tag depends on the instruction it is associated with. Thus, the same tag applied to a load instruction may produce a different behavior when applied to a store instruction.

Multiple instruction tags may simultaneously apply to a single instruction and are combined as a separate, single tag that combines the function of the constituent tags. For example, an arithmetic instruction that operates on a data pointer (tag [DPO]) may also be the target of a function call (tag [TFC]), as it is typically the case for the instruction that adjusts the stack pointer in function prologues. In this case, the single combined tag is represented as [TFC+DPO] and encoded to have the same width as each of the constituent tags.

TABLE 2
Instruction Tags

| Instruction Tag | |
|---|---|
| (symbolic | |
| representation) | Usage |
| [GEN] | Applies to any instruction that does not implement tag-driven security |
| | policies based on specific data types. However, data type consistencies |
| | are checked to detect potential illegal usage or type violations. |
| [CPO] | Used to tag instructions that operate on code pointer or perform |
| | memory access using code pointers. |
| [DPO] | Used to tag instructions that operate on data pointer or perform |
| | memory access using code pointers |
| [CLR] | Sets the data tag of the addressed memory location to [DT] and clears |
| | the contents associated with the memory location after its contents are |
| | retrieved by a LOAD instruction; for a store instruction, the addressed |
| | memory location's tag is set to [DT] and its contents are cleared. |
| [RAP] | Applies to memory instructions that LOAD or STORE a return address, |
| | that is, read a return address resident in the main memory or stores a |
| | return address into a memory location, respectively. |
| [CAL] | Tags a control-flow instruction that can make a function call. |
| [RET] | Tags a control-flow instruction that is used to return from a function |
| | call. |
| [TFC] | This tags the instruction at the entry point of a called function |
| [TFR] | This tags the instruction to which control returns to within the calling |
| | function at the conclusion of a function call |
| [TIJ] | This tags the instruction at the target of an indirect jump instruction, |
| | which computes the address of the target just prior to the call |
| [LBL] | Identifies a control flow label that associates a control flow instruction |
| | with it's intended transfer instruction. The same unique label precedes |
| | the control flow instruction as well as the instruction that it transfers |
| | control to. |

### Security Policies

The security policies enforced by SP for each instruction group are described separately.

Control Transfer Instructions. Every function call instruction is tagged [CAL]. The instruction that immediately follows the call is tagged [TFR]. The instruction at the target of the call is tagged [TFC]. Additionally, if the target function is unreachable within the compilation unit (i.e., its address is unknown at compile time), a CFI-label is inserted before the call in the form of a no-op instruction with the tag [LBL]. Likewise, each global function reachable by other compilation units has a matching CFI label at function entry points.

Control flow labels are special instruction-sized entities that appear within the compiled binary, looking just like an instruction and use the [LBL] tag to identify parts or all on the fields within the associated instruction-sized field as the constituents of an unique identifier called a label. Such control flow labels are generated by a compiler and allows a control flow instruction to be matched to a specific instruction that is the destination of the control transfer, as indicated in Table 2. Even though source labels are always followed by a call instruction, checking whether that is the case upon encountering a CFI label in the hardware would require a complex lookahead logic for reading the next instruction ahead of time. Since the hardware pipeline naturally fetches the instruction following the label in the next cycle, this check can be delayed until then without sacrificing security. Thus, the hardware uses the label type field to internally activate the check for the call instruction in the next cycle. The remaining 19 bits are used to implement a function-signature based CFI-scheme comprised of the function return type, first five argument types, and a flag to denote if the function is variadic. The CFI label itself is tagged [LBL], so that it can be distinguished from other no-op instructions.

When a call instruction executes, the register that stores the return address receives the data tag [RA]. From then on, only the memory instructions tagged [RAP] may load/store the return address. Furthermore, every return instruction is tagged [RET], which enforces that the register holding the return address is tagged [RA]. A return instruction can transfer control only to an instruction tagged [TFR].

Program counter relative (PC-Relative) jumps and branches have their targets verified at compile time and are not subject to additional security checks. On the other hand, every indirect jump instruction is required by the hardware at runtime to use a code pointer in its source register with the data tag [CP]. There is no instruction tag that identifies an indirect jump: any computed jump that is not a function call or a return, which are tagged [CAL] and [RET] respectively, is an indirect jump. For this reason, indirect jumps are tagged [GEN]. However, the instructions targeted by indirect jumps are tagged [TIJ] and the hardware enforces that the instruction following an indirect jump must be tagged [TIJ]. Note that direct jumps targeting an instruction tagged [TIJ] are still allowed; the target check is activated only upon encountering an indirect jump instruction.

In summary, the following protection mechanisms are provided to support control flow integrity:
Forward Edge Integrity: Provided by pairing function calls tagged [CAL] and instructions at the target tagged [TFC] for functions resolved at compile time; by pairing compile-time unresolved functions using source and destination CFI labels tagged [LBL]; and by pairing indirect jumps tagged [GEN] with their potential targets tagged [TIJ]. Additionally, all control transfer instructions must use a source register tagged [CP] to ensure that the control transfer always happens using a code pointer.
Backward Edge Integrity: Provided by pairing function return instructions tagged [RET] with their targets tagged [TFR]. All return instructions must use a source register tagged as [RA]. Moreover, only the execution of an instruction with tag [CAL] will lead to tagging of the return address register [RA]. The data tag makes the return address tamper-evident. Only the memory instructions tagged [RAP] may operate on it. Any other instruction invalidates the [RA] tag and replaces it with [DT].

Examples of security policies related to control flow integrity and pointer integrity are described below.

### Function Call Policy:

The function calling instruction is tagged with [CAL] and this directs the hardware to check if the register argument used to calculate the address of the called function is a code pointer (tagged as [CP]). It also forces a check to see if the instruction at the address of the function is tagged with a [TFC], to indicate it as the target of a function call. If either of these two checks fails, a security violation is flagged. If both checks pass, control is transferred to the called function after saving the return address, tagged with [RA] in the register specified for saving the return address.

### Function Return Policy:

[RET] jalr zero, ra, 0: The instruction that transfers control back from the called function to the calling function is tagged with [RET] and this directs the hardware to check if the register argument used to calculate the address of the instruction to which control returns to is tagged as a return address (tagged as [RA]). It also forces a check to see if the instruction to which control returns to is tagged as [TFR]. If either of these two checks fails, a security violation is flagged. If both checks pass, control is transferred back to the caller.

### Indirect Jump Policy:

The indirect jump instruction is tagged with [GEN] and this checks if the register used to calculate the address of the target of the indirect jump is a code pointer (tagged as [CP]). It also checks if the instruction at the target is tagged with [TIJ] as the target of an indirect jump. If either of these two checks fail, a security violation is flagged, otherwise, control transfer takes place to the instruction at the computed target address.

Note that checking of the control transfer tags [TFC], [TFR], [TIJ], are done slightly differently in the hardware to improve performance. Instead of performing a memory operation to check the target instruction tag, a latch is set in the hardware that triggers the check while executing the target instruction in the pipeline. This latch is preserved across context switches as part of a process' context. Moreover, control transfer target checks are not triggered for fall-through code; only a control transfer instruction or a CFI label at the source activates the checks for the target. Additionally, a label-based CFI check makes [TFC] redundant for functions that have a CFI label at their entry points, since it is more fine-grained. In such cases, the SP compiler doesn't tag the instruction at the entry point [TFC], and the hardware skips the check for the corresponding call instructions tagged [CAL].

Memory Instructions. The security policies for memory instructions focus on providing return address protection, pointer integrity, and information leakage mitigation between registers and memory. Generic load and store operations that don't require extra security checks are tagged [GEN]. The associated data tags propagate between registers and memory with the exception of the data tag [RA]: generic memory operations are not allowed to operate on return addresses. This is to say that a generic load cannot read from a memory location tagged [RA] and a generic store cannot store a register tagged [RA]. However, a generic store can overwrite a memory location tagged [RA] with a register tagged anything but [RA]. The [GEN] tag also enables helpers such as memcpy ( ) to function properly without additional special handling.

When the SP compiler determines that a memory operation loads or stores a data pointer or code pointer, it tags the instruction [DPO] or [CPO] respectively. The return address push and pop memory operations must be tagged [RAP]. When applied to a store instruction, it enforces that the source register must have the data tag [RA]. Similarly, a load instruction tagged [RAP] ensures that the tag of the memory location is [RAJ, before moving it into the register. Additionally, memory instructions can be associated with the tag [CLR], which clears the source register and sets its data tag to [DT] for stores; and clears the contents of the memory location and sets its data tag to [DT] for loads. When used in combination with [RAP], it ensures that there is always only one copy of the return address at any given time either in a register or memory, preventing any potential abuse based on reusing the return address.

Support for setjmp/longjmp: Return address push/pop instructions without the additional [CLR] tag are used to support setjmp ( )/longjmp ( ) such that the same setjmp buffer can be reused by multiple longjmp ( ) calls without invalidating the return address saved as part of the context.

Defense against use after free: The [CLR] tag can be used in a similar fashion on pointers before they are freed to limit the attack surface for use-after-free attacks. This is accomplished by tagging the pointer load instruction that precedes the free with [CLR], effectively invalidating the pointer in memory. We′d like to reiterate that no extra instructions need to be inserted to utilize this feature thanks to the SP instruction tagging. However, coverage depends on the availability and the compiler's ability to identify applicable instructions where this feature can be leveraged.

In summary, the following protection mechanisms are provided by the memory-related security policies:
Return Address Integrity: Provided by only allowing designated instructions tagged [RAP] to access the return address; by detecting any tampering of a return address through the data tag [RA]; by ensuring that the return address push/pop operations don't leave a copy behind in a register or memory for potential abuse through the use of [CLR].
Data Pointer Integrity: Provided by ensuring that the memory instructions tagged [DPO] exclusively load/store data pointers tagged [DP]; by detecting tampering of data pointers through the data tag [DP].
Code Pointer Integrity: Provided by ensuring that the memory instructions tagged [CPO] exclusively load/store code pointers tagged [CP]; by detecting tampering of code pointers through the data tag [CP].

Below is a summary of the security policies enforced by each tag that applies to memory operations:

### Load Policies:

LOAD instructions, depending on their instruction tag, implement several security policies. These are as follows:

A load instruction tagged with [GEN] checks if the register used to calculate the address of the memory location is tagged as a data pointer ([DP]). It also checks that the data loaded from memory is not a return address (that is, tagged with [RA]). If either of these checks fails, a security violation is flagged, otherwise, the load operation completes normally and copies the tag of the memory location into a tag extension of the register being loaded.

A load instruction tagged with [DPO] is used to load a data pointer from memory into a register. The [DPO] tag in this case forces a check to see if the register used to calculate the memory address is itself a data pointer (tagged as [DP]) and if the data retrieved from memory is a data pointer (tagged with [DP]). If any of these checks fail, a security violation is triggered.

A load instruction tagged with [CPO] is intended to load a code pointer from memory into a register and forces the following checks. It checks if the register used to calculate the memory address is itself a data pointer (tag [DP]) and if the data retrieved from memory is a code pointer. If any of these two checks fail, a security violation is triggered.

A load instruction tagged with [RAP] is intended to load a return address from memory into a register and forces the following checks. It checks if the register used to calculate the memory address is itself a data pointer (tag [DP]) and if the data retrieved from memory is a return address (tag [RA]). If the two checks pass, the return address is loaded to the specified register, along with its tag in the extension of that register and, further, the tag of the memory location accessed is set to that of ordinary data, [DT].

A load instruction tagged with [CLR] is intended to clear out a memory location, after retrieving data from memory. In doing this, it checks if the register used to calculate the memory address is tagged as [DP]. If this check fails, a security violation is tagged, otherwise the memory location's contents and its tag are read into the specified destination register and after this retrieval, the tag is of the memory location is changed to [DT] and the memory location's contents is set to zero.

### Store Policies:

STORE instructions, depending on their instruction tag, implement several security policies. These are as follows:

A store instruction tagged with [GEN] checks if the register used to calculate the memory location's address is tagged with a [DP] and also checks that the register being stored is not tagged as a return address (tag [RA]). If either of these checks fail, a security violation is triggered, otherwise the specified register to be stored is written to memory along with its data tag to the respective data tag memory location.

A store tagged with [DPO] is intended to store a data pointer into a memory location. The tag [DPO] forces a check to ensure that the register used to calculate the memory address is tagged as [DP] and whether the register being written to memory is tagged with as a data pointer. If either of the two checks fail, a security violation is triggered, otherwise the specified register's contents and its associated tag are written to the memory location whose address was computed and to its corresponding data tag location, respectively.

A store tagged with [CPO] is intended to store a code pointer into a memory location. The tag [CPO] forces a check to ensure that the register used to calculate the memory address is tagged as [DP] and whether the register being written to memory is tagged with as a code pointer with the tag [CP]. If either of the two checks fail, a security violation is triggered, otherwise the specified register's contents and its associated tag are written to the memory location whose address was computed and to its corresponding data tag location, respectively.

A store tagged with [RAP] is intended to store a return address into a memory location. The tag [RAP] forces a check to ensure that the register used to calculate the memory address is tagged as [DP] and whether the register being written to memory is tagged as a return address with the tag [RA]. If either of the two checks fail, a security violation is triggered, otherwise the specified register's contents and its associated tag are written to the memory location whose address was computed and to its corresponding data tag location, respectively.

A load instruction tagged with [CLR] simply calculates a memory address after checking that the register used to calculate the memory address is tagged with [DP] and set the tag of the memory location whose address was calculated to zero and sets it associated data tag to [DT].

Arithmetic Instructions. The SP security policies for arithmetic instructions provide protections for pointer integrity and limited type safety. As data of a certain type in a register interacts with other registers, the type information must propagate appropriately. For example, an add instruction with the sole intention of adding two numeric values in separate registers must never operate on a pointer value, or output data of pointer type. A system that would prevent such vulnerabilities must also be flexible enough to allow an add instruction to either operate on two numeric values or a pointer and a numeric value (e.g., pointer increment). While doing so, it must accurately deduce at runtime that the former produces a numeric value while the latter a pointer value. Well-known type safety principles are used to calculate the tag of the result. Instructions tagged with [CPO] are the only ones that can perform arithmetic on code pointers or compare code pointers. Instructions that use specified literals to form all or part of a code pointer are also tagged with [CPO]. Similarly, instructions tagged with [DPO] are the only ones that can perform arithmetic on data pointers or compare data pointers. Instructions that use specified literals to form all or part of a data pointer are also tagged with [DPO]. Tagging arithmetic or register-to-register instructions with [CPO] or [DPO] restricts their operations to the specific pointer types and thus prevents other arithmetic instructions from calculating code or data pointers illegally or from modifying pointers illegally, thus enhances pointer integrity.

### SP Security Tagging in Use and Security Evaluations

Code reuse attacks like ROP, JOP and return-to-libc all rely on illegal pointer modification through the use of buffer overflows and other mechanisms. SP's security tagging marks the pointers with the tag [DT] on such modifications and the original pointer tags are lost, so control flow instructions are unable to launch these attacks. Return addresses used to resume after a call can only be used if they remain tagged with [RA] in the register that holds them after retrieval from the stack. Gadget formation, relying on stringing together existing instructions, is further discouraged by allowing control flows into arbitrary instructions that are not marked as a target (using the tags [TFC], [TFR], [TIJ]) or to ones preceded by a label. Labeling indirect jump targets as described also ensures proper control flow into the intended targets from legal source instructions that do the control transfer.

### Implementation of the SP Architecture

### Inline Instruction Tags

Instruction tagging requires extra storage to hold the tags. The current SP implementation relies on the use of a 6-bit tag for regular 32-bit instructions in the RISCV ISA. Instruction tags are co-located with instructions in the program executable, close to the instructions they correspond to. This is called Inline Tagging and eliminates extra memory accesses needed for locating and retrieving instruction tags had they been placed in a memory area separate and distinct from the memory area holding the executable. This particular choice of the tag width was made to enable instruction tagging to support security functions that go well beyond what is needed for enforcing the control flow and pointer integrity. Alternative choices exist for using wider instruction tags for more security measures or narrower instruction tags for restricted security applications—these are not discussed here for brevity.

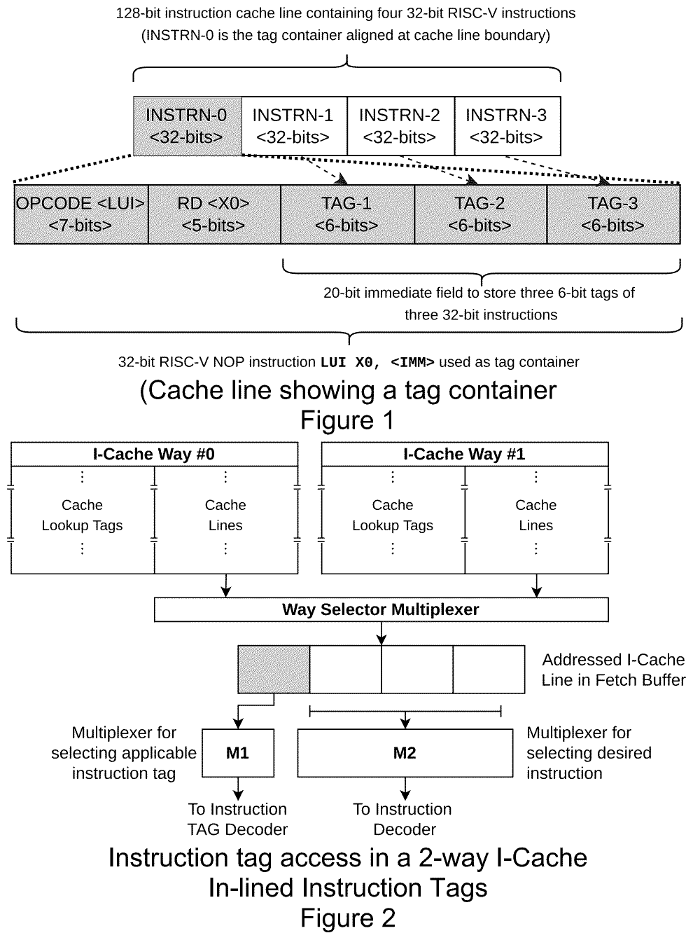

The inline tagging scheme of the current implementation uses a single 4-byte tag field encoded as a no-op instruction within a cache line to cover three regular RISC-V instructions that follow the tag field. The tag field is aligned to start at a 16-byte boundary, making it simple for the tag to be located quickly within a cache line (FIG. 1). The PC counter update logic is aware of the presence of the tag field within a cache line and automatically increments when it points to a tag field to point to the next instruction to be fetched. The compiler analysis phase generates the proper information to appropriately adjust offsets used for control transfers and instructions, in general. The performance penalty that comes from inlining instruction tags within the executable can be easily mitigated to acceptable levels (low single digit percentages) through the use of modest increase in the cache size and/or through the selection of cache parameters. As shown in FIG. 2, instruction tag and instruction opcode decoding proceed concurrently, without introducing any critical path that forces the use of a slower clock.

Generalized Instruction Tagging. The technique of inlining instruction tags within the binary is generalized and not restricted to a particular tag size or a particular I-cache line size. The general principle calls for placing the tags within a cache line in fields (called tag fields) of fixed sizes with pre-determined alignments. For instance, in a 32-byte cache line, the tags may be placed within a single 4-byte line, aligned at 32-byte boundaries. If the cache line is 64 bytes, two such fields can appear in a single cache line, or, in an alternative implementation, a single 8-byte field, aligned at 64-byte boundary can be used. Although the tag inlining is particularly suited for RISC ISAs that have uniform sized instructions, it can also be adopted for CISC ISAs.

The number of tags appearing in the tag field within an I-Cache line can also change based on the size of the tags assigned. With a fixed size for all instructions, the tags can have a fixed size and correspond to the instructions one-to-one that follow the tag field to the commencement of the next tag field.

The SP implementation described herein is restricted to only the regular 32-bit instruction subset of the RISC-V ISA. To accommodate 16-bit compressed instructions, mixed in with 32-bit regular instructions, the tags for the former are kept at half the size of the regular 32-bit instructions to facilitate tag identification and placement within tag containers.

Narrower Instruction Tags. The tag assignment in the present SP hardware prototype uses a flat namespace; bit patterns in this namespace are allocated irrespective of the instructions they apply to. Functionally, the use of a particular tag is restricted to a few classes of instructions. Given this, one possibility is to interpret the tag depending on the opcode of the instruction. In the RISC-V implementations, opcode decoding proceeds in two steps—the first is the decoding to an instruction class (load, store, operation, control flow etc.), followed by the decoding of the opcode within the class. Opcode dependent tag interpretation introduces a short delay preceding tag decoding but uses tag namespace effectively.

### Handling Self-Modifying and JIT Code

In SP, binaries cannot be overwritten, as embedded instruction tags can be overwritten to enable exploits. To support self-modifying and JIT code, the functions performing the modifications will have to be trusted and designed to insert the correct instruction tags. The self modifying code has to be tagged itself and access to it will have to be secured through control flow labels. To enable tagged code modifications in memory, a special handler will have to be supported, with the address of the self-modifying function pre-registered with it to enable the binary overwrites to proceed without a security exception. Software sandboxing can be used additionally to limit the range of memory locations affected by the self-modifying functions.

References (each of which is expressly incorporated herein by reference in its entirety):
[1] “CBench: Check Your CFI's Failed Protections,” github.com/vul337/cfi-eval/tree/master/cbench.
[2] “RIPE 64-bit benchmark repository,” github.com/hrosier/ripe64.
[3] M. Abadi, M. Budiu, U. Erlingsson, and J. Ligatti, “Control-flow integrity,” in Proceedings of the 12th ACM Conference on Computer and Communications Security. New York, NY, USA: Association for Computing Machinery, 2005, p. 340-353.
[4] M. Abadi, M. Budiu, U. Erlingsson, and J. Ligatti, “Control-flow integrity principles, implementations, and applications,” ACM Transactions on Information and System Security (TISSEC), vol. 13, no. 1, pp. 1-40, 2009.
[5] E. Aktas, F. Afram, and K. Ghose, “Continuous, low overhead, run-time validation of program executions,” in 2014 47th Annual IEEE/ACM International Symposium on Microarchitecture, 2014, pp. 229-241.
[6] S. Andersen, “Changes to functionality in microsoft windows XP service pack 2,” Microsoft technical document, August 2004.
[7] A. Bittau, A. Belay, A. Mashtizadeh, D. Mazieres, and D. Boneh, “Hacking blind,” in 2014 IEEE Symposium on Security and Privacy. IEEE, 2014, pp. 227-242.
[8] T. Bletsch, X. Jiang, and V. Freeh, “Mitigating code-reuse attacks with control-flow locking,” in Proceedings of the 27th Annual Computer Security Applications Conference, 2011, pp. 353-362.
[9] T. Bletsch, X. Jiang, V. W. Freeh, and Z. Liang, “Jump-oriented programming: a new class of code-reuse attack,” in Proceedings of the 6th ACM Symposium on Information, Computer and Communications Security, 2011, pp. 30-40.
[10] “Flute open source code,” github.com/bluespec/Flute, Bluespec Inc.
[11] A. Bradbury, G. Ferris, and R. Mullins, “Tagged memory and minion cores in the lowRISC SoC,” Memo, University of Cambridge, 2014.
[12] N. Carlini, A. Barresi, M. Payer, D. Wagner, and T. R. Gross, “Control-flow bending: On the effectiveness of control-flow integrity,” in 24th USENIX Security Symposium (USENIX Security 15), 2015, pp. 161-176.
[13] S. Checkoway, L. Davi, A. Dmitrienko, A.-R. Sadeghi, H. Shacham, and M. Winandy, “Return-oriented programming without returns,” in Proceedings of the 17th ACM conference on Computer and communications security, 2010, pp. 559-572.
[14] K. Chen, C. Zhang, T. Yin, X. Chen, and L. Zhao, “VScape: Assessing and escaping virtual call protections,” in 30th USENIX Security Symposium (USENIX Security 21), 2021, pp. 1719-1736.
[15] N. Christoulakis, G. Christou, E. Athanasopoulos, and S. Ioannidis, “HCFI: Hardware-enforced control-flow integrity,” in Proceedings of the Sixth ACM Conference on Data and Application Security and Privacy, 2016, pp. 38-49.
[16] C. Cowan, C. Pu, D. Maier, J. Walpole, P. Bakke, S. Beattic, A. Grier, P. Wagle, Q. Zhang, and H. Hinton, “Stackguard: automatic adaptive detection and prevention of buffer-overflow attacks.” in USENIX security symposium, vol. 98. San Antonio, TX, 1998, pp. 63-78.
[17] T. H. Dang, P. Maniatis, and D. Wagner, “The performance cost of shadow stacks and stack canaries,” in Proceedings of the 10th ACM Symposium on Information, Computer and Communications Security, 2015, pp. 555-566.
[18] L. Davi, M. Hanreich, D. Paul, A.-R. Sadeghi, P. Koeberl, D. Sullivan, O. Arias, and Y. Jin, “HAFIX: Hardware-assisted flow integrity extension,” in 2015 52nd ACM/EDAC/IEEE Design Automation Conference (DAC). IEEE, 2015, pp. I-6.
[19] L. Davi, P. Koeberl, and A.-R. Sadeghi, “Hardware-assisted finegrained control-flow integrity: Towards efficient protection of embedded systems against software exploitation,” in 2014 51st ACM/EDAC/IEEE Design Automation Conference (DAC). IEEE, 2014, pp. I-6.
[20] L. Davi and A.-R. Sadeghi, “Building control-flow integrity defenses,” in Building Secure Defenses Against Code-Reuse Attacks. Springer, 2015, pp. 27-54.
[21] L. Davi, A.-R. Sadeghi, D. Lehmann, and F. Monrose, “Stitching the gadgets: On the ineffectiveness of coarse-grained control-flow integrity protection,” in 23rd USENIX Security Symposium (USENIX Security 14), 2014, pp. 401-416.
[22] A. De, A. Basu, S. Ghosh, and T. Jaeger, “FIXER: Flow integrity extensions for embedded RISC-V,” in 2019 Design, Automation & Test in Europe Conference & Exhibition (DATE). IEEE, 2019, pp. 348-353.
[23] A. A. De Amorim, M. De′ne's, N. Giannarakis, C. Hritcu, B. C. Pierce, A. Spector-Zabusky, and A. Tolmach, “Micro-policies: Formally verified, tag-based security monitors,” in 2015 IEEE Symposium on Security and Privacy. IEEE, 2015, pp. 813-830.
[24] A. DeHon, E. Boling, R. Nikhil, D. Rad, J. Schwarz, N. Sharma, J. Stoy, G. Sullivan, and A. Sutherland, “DOVER: A metadataextended RISC-V,” in RISC-V Workshop, 2016.
[25] D. Demicco, M. Cole, G. Yuksek, R. T. Gollapudi, A. Prakash, K. Ghose, and Z. Umrigar, “Generic Tagging for RISC-V Binaries.” arXiv preprint, 2022.
[26] U. Dhawan, C. Hritcu, R. Rubin, N. Vasilakis, S. Chiricescu, J. M. Smith, T. F. Knight Jr, B. C. Pierce, and A. DeHon, “Architectural support for software-defined metadata processing,” in Proceedings of the Twentieth International Conference on Architectural Support for Programming Languages and Operating Systems, 2015, pp. 487-502.
[27] U. Dhawan, N. Vasilakis, R. Rubin, S. Chiricescu, J. M. Smith, T. F. Knight, B. C. Pierce, and A. DeHon, “Pump: A programmable unit for metadata processing,” in Proceedings of the Third Workshop on Hardware and Architectural Support for Security and Privacy, ser. HASP '14. New York, NY, USA: Association for Computing Machinery, 2014. [Online]. Available: doi.org/10.1145/2611765.2611773
[28] R. Ding, C. Qian, C. Song, B. Harris, T. Kim, and W. Lee, “Efficient protection of path-sensitive control security,” in 26th USENIX Security Symposium (USENIX Security 17), 2017, pp. 131-148.
[29] I. Evans, F. Long, U. Otgonbaatar, H. Shrobe, M. Rinard, H. Okhravi, and S. Sidiroglou-Douskos, “Control jujutsu: On the weaknesses of fine-grained control flow integrity,” in Proceedings of the 22nd ACM SIGSAC Conference on Computer and Communications Security, 2015, pp. 901-913.
[30] E. Go “ktas, E. Athanasopoulos, H. Bos, and G. Portokalidis, “Out of control: Overcoming control-flow integrity,” in 2014 IEEE Symposium on Security and Privacy. IEEE, 2014, pp. 575-589.
[31] H. Hu, C. Qian, C. Yagemann, S. P. H. Chung, W. R. Harris, T. Kim, and W. Lec, “Enforcing unique code target property for control-flow integrity,” in Proceedings of the 2018 ACM SIGSAC Conference on Computer and Communications Security, 2018, pp. 1470-1486.
[32] H. Hu, S. Shinde, S. Adrian, Z. L. Chua, P. Saxena, and Z. Liang, “Data-oriented programming: On the expressiveness of non-control data attacks,” in 2016 IEEE Symposium on Security and Privacy (SP). IEEE, 2016, pp. 969-986.
[33] Intel Corporation, “Control-flow enforcement technology preview,” www.intel.com/content/dam/develop/external/us/en/documents/catc 17-introduction-intel-cet-844137.pdf, 2016.
[34] A. J. Joannou, “High-performance memory safety: optimizing the cheri capability machine,” University of Cambridge, Computer Laboratory, Tech. Rep., 2019.
[35] M. Khandaker, A. Naser, W. Liu, Z. Wang, Y. Zhou, and Y. Cheng, “Adaptive call-site sensitive control flow integrity,” in 2019 IEEE European Symposium on Security and Privacy (EuroS&P). IEEE, 2019, pp. 95-110.
[36] M. R. Khandaker, W. Liu, A. Naser, Z. Wang, and J. Yang, “Originsensitive control flow integrity,” in 28th USENIX Security Symposium (USENIX Security 19), 2019, pp. 195-211.
[37] V. Kuznetzov, L. Szekeres, M. Payer, G. Candea, R. Sckar, and D. Song, “Code-pointer integrity,” in The Continuing Arms Race: Code-Reuse Attacks and Defenses, 2018, pp. 81-116.
[38] J. Li, L. Chen, G. Shi, K. Chen, and D. Meng, “ABCFI: Fast and lightweight fine-grained hardware-assisted control-flow integrity,” IEEE Transactions on Computer-Aided Design of Integrated Circuits and Systems, vol. 39, no. 11, pp. 3165-3176, 2020.
[39] lowRISC, “RISC-V LLVM,” github.com/lowRISC/riscv-llvm.
[40] V. Mohan, P. Larsen, S. Brunthaler, K. W. Hamlen, and M. Franz, “Opaque control-flow integrity.” in NDSS, vol. 26, 2015, pp. 27-30.
[41] A. Mujumdar, “Armv8.1-M Pointer Authentication and Branch Target Identification Extension,” community.arm.com/armcommunity-blogs/b/architectures-and-processors-blog/posts/armv81-m-pointer-authentication-and-branch-target-identificationextension, 2021.
[42] S. Nagarakatte, M. M. Martin, and S. Zdancewic, “Watchdoglite: Hardware-accelerated compiler-based pointer checking,” in Proceedings of Annual IEEE/ACM International Symposium on Code Generation and Optimization, 2014, pp. 175-184.
[43] S. Nagarakatte, J. Zhao, M. M. Martin, and S. Zdancewic, “CETS: compiler enforced temporal safety for C,” in Proceedings of the 2010 International Symposium on Memory Management, 2010, pp. 31-40.
[44] T. Newsham, “Format string attacks,” people.cs.georgetown. cdu/˜clay/classes/spring2019/ia/format-string-attacks.pdf, 2000.
[45] B. Niu and G. Tan, “Modular control-flow integrity,” in Proceedings of the 35th ACM SIGPLAN Conference on Programming Language Design and Implementation, 2014, pp. 577-587.
[46] B. Niu and G. Tan, “RockJIT: Securing just-in-time compilation using modular control-flow integrity,” in Proceedings of the 2014 ACM SIGSAC Conference on Computer and Communications Security, 2014, pp. 1317-1328.
[47] A. One, “Smashing the stack for fun and profit,” Phrack magazine, vol. 7, no. 49, pp. 14-16, 1996.
[48] H. Ozdoganoglu, T. Vijaykumar, C. E. Brodley, B. A. Kuperman, and A. Jalote, “SmashGuard: A hardware solution to prevent security attacks on the function return address,” IEEE Transactions on Computers, vol. 55, no. 10, pp. 1271-1285, 2006.
[49] T. PaX, “PaX address space layout randomization (ASLR),” pax. grsecurity. net/docs/aslr. txt, 2003.
[50] P. Qiu, Y. Lyu, J. Zhang, D. Wang, and G. Qu, “Control flow integrity based on lightweight encryption architecture,” IEEE Transactions on Computer-Aided Design of Integrated Circuits and Systems, vol. 37, no. 7, pp. 1358-1369, 2017.
[51] N. Roessler and A. DeHon, “Protecting the stack with metadata policies and tagged hardware,” in 2018 IEEE Symposium on Security and Privacy (SP). IEEE, 2018, pp. 478-495.
[52] F. Schuster, T. Tendyck, C. Liebchen, L. Davi, A.-R. Sadeghi, and T. Holz, “Counterfeit object-oriented programming: On the difficulty of preventing code reuse attacks in C++ applications,” in 2015 IEEE Symposium on Security and Privacy. IEEE, 2015, pp. 745-762.
[53] H. Shacham, “The geometry of innocent flesh on the bone: Returninto-libc without function calls (on the x86),” in Proceedings of the 14th ACM conference on Computer and communications security, 2007, pp. 552-561.
[54] V. Shanbhogue, D. Gupta, and R. Sahita, “Security analysis of processor instruction set architecture for enforcing control-flow integrity,” in Proceedings of the 8th International Workshop on Hardware and Architectural Support for Security and Privacy, ser. HASP '19, 2019.
[55] K. Z. Snow, F. Monrose, L. Davi, A. Dmitrienko, C. Liebchen, and A.-R. Sadeghi, “Just-in-time code reuse: On the effectiveness of fine-grained address space layout randomization,” in 2013 IEEE Symposium on Security and Privacy. IEEE, 2013, pp. 574-588.
[56] C. Song, H. Moon, M. Alam, I. Yun, B. Lee, T. Kim, W. Lee, and Y. Paek, “HDFI: Hardware-assisted data-flow isolation,” in 2016 IEEE Symposium on Security and Privacy (SP). IEEE, 2016, pp. 1-17.
[57] W. Song, A. Bradbury, and R. Mullins, “Towards general purpose tagged memory,” in Proceedings of the RISC-V Workshop, 2015. [Online]. Available: riscv.org/wp-content/uploads/2015/06/riscv-tagged-mem-workshop-june2015.pdf
[58] D. Sullivan, O. Arias, L. Davi, P. Larsen, A.-R. Sadeghi, and Y. Jin, “Strategy without tactics: Policy-agnostic hardware-enhanced controlflow integrity,” in 2016 53nd ACM/EDAC/IEEE Design Automation Conference (DAC). IEEE, 2016, pp. I-6.
[59] G. T. Sullivan, A. DeHon, S. Milburn, E. Boling, M. Ciaffi, J. Rosenberg, and A. Sutherland, “The dover inherently secure processor,” in 2017 IEEE International Symposium on Technologies for Homeland Security (HST), 2017, pp. 1-5.
[60] L. Szekeres, M. Payer, T. Wei, and D. Song, “Sok: Eternal war in memory,” in 2013 IEEE Symposium on Security and Privacy. IEEE, 2013, pp. 48-62.
[61] M. Tran, M. Etheridge, T. Bletsch, X. Jiang, V. Freeh, and P. Ning, “On the expressiveness of return-into-libc attacks,” in International Workshop on Recent Advances in Intrusion Detection. Springer, 2011, pp. 121-141.
[62] V. van der Veen, D. Andriesse, E. Göktas, B. Gras, L. Sambuc, A. Slowinska, H. Bos, and C. Giuffrida, “Practical context-sensitive CFI,” in Proceedings of the 22nd ACM SIGSAC Conference on Computer and Communications Security. New York, NY, USA: Association for Computing Machinery, 2015, p. 927-940.
[63] R. N. Watson, J. Woodruff, P. G. Neumann, S. W. Moore, J. Anderson, D. Chisnall, N. Dave, B. Davis, K. Gudka, B. Laurie, S. J. Murdoch, R. Norton, M. Roc, S. Son, and M. Vadera, “Cheri: A hybrid capability-system architecture for scalable software compartmentalization,” in 2015 IEEE Symposium on Security and Privacy, 2015, pp. 20-37.
[64] S. Weiser, M. Werner, F. Brasser, M. Malenko, S. Mangard, and A.-R. Sadeghi, “TIMBER-V: Tag-isolated memory bringing fine-grained enclaves to RISC-V.” in NDSS, 2019.
[65] J. Woodruff, R. N. M. Watson, D. Chisnall, S. W. Moore, J. Anderson, B. Davis, B. Laurie, P. G. Neumann, R. Norton, and M. Roe, “The cheri capability model: Revisiting risc in an age of risk,” in 2014 ACM/IEEE 41st International Symposium on Computer Architecture (ISCA), 2014, pp. 457-468.
[66] Y. Xia, Y. Liu, H. Chen, and B. Zang, “CFIMon: Detecting violation of control flow integrity using performance counters,” in IEEE/IFIP International Conference on Dependable Systems and Networks (DSN 2012). IEEE, 2012, pp. 1-12.
[67] C. Zhang, T. Wei, Z. Chen, L. Duan, L. Szekeres, S. McCamant, D. Song, and W. Zou, “Practical control flow integrity and randomization for binary executables,” in 2013 IEEE Symposium on Security and Privacy. IEEE, 2013, pp. 559-573.
[68] M. Zhang and R. Sekar, “Control flow integrity for COTS binaries,” in 22nd USENIX Security Symposium (USENIX Security 13), 2013, pp. 337-352.
[69] M. T. I. Ziad, M. A. Arroyo, E. Manzhosov, and S. Sethumadhavan, “Zerø: Zero-overhead resilient operation under pointer integrity attacks,” in 2021 ACM/IEEE 48th Annual International Symposium on Computer Architecture (ISCA). IEEE, 2021, pp. 999-1012.
[70] J. R. Crandall, F. T. Chong, and S. F. Wu, “Minos: Architectural support for protecting control data,” ACM Transactions on Architecture and Code Optimization, vol. 5, pp. 359-389, December 2006.
[71] N. Vachharajani, M. J. Bridges, J. Chang, R. Rangan, G. Ottoni, J. A. Biome, G. A. Reis, M. Vachharajani, and D. I. August, “RIFLE: An architectural framework for user-centric information-flow security,” in 37th International Symposium on Microarchitecture, 2004.
[72] S. Chen, J. Xu, N. Nakka, Z. Kalbarczyk, and R. Iyer, “Defeating memory corruption attacks via pointer taintedness detection,” in International Conference on Dependable Systems and Networks (DSN), pp. 378-387, 2005.
[73] J. A. Clause, W. Li, and A. Orso, “Dytan: a generic dynamic taint analysis framework,” in ACM/SIGSOFT International Symposium on Software Testing and Analysis (ISSTA), pp. 196-206, ACM, 2007. [5] M. G. Kang, S. McCement, P. Poosankam, and D. Song, “DTA++: Dynamic taint analysis with targeted control-flow propagation,” in Network and Distributed System Security Symposium (NDSS), The Internet Society, 2011.
[74] Y.-Y. Chen, P. A. Jamkhedkar, and R. B. Lee, “A software-hardware architecture for self-protecting data,” in ACM Conference on Computer and Communications Security, pp. 14-27, ACM, 2012.
[75] G. E. Suh, J. W. Lee, D. Zhang, and S. Devadas, “Secure program execution via dynamic information flow tracking,” in International Conference on Architectural Support for Programming Languages and Operating Systems, pp. 85-96, 2004.
[76] G. Venkataramani, B. Roemer, Y. Solihin, and M. Prvulovic, “Memtracker: Efficient and programmable support for memory access monitoring and debugging,” in Proceedings of the International Symposium on High Performance Computer Architecture, pp. 273-284, 2007.
[77] N. P. Carter, S. W. Keckler, and W. J. Daily, “Hardware support for fast capability-based addressing,” in Proceedings of the international conference on Architectural support for programming languages and operating systems, ASPLOS-VI, pp. 319-327, 1994.
[78] P. Akritidis, M. Costa, M. Castro, and S. Hand, “Baggy bounds checking: an efficient and backwards-compatible defense against out-of-bounds errors,” in Proceedings of the 18th Conference on USENIX Security Symposium, pp. 51-66, 2009.
[79] S. Nagarakatte, M. M. K. Martin, and S. Zdancewic, “Hardware-Enforced Comprehensive Memory Safety,” IEEE Micro, vol. 33, pp. 38-47, May-June 2013.
[80] K. Ganesh, “Pointer checker: Easily catch out-of-bounds memory access,” The Parallel Universe, 2012.
[81] R. Prakash, “The holy grail-real time memory access checking.” Online blogs.oracle.com/rayentry/the_holy_grail_real_time, October 2015.
[82] E. Göktaç, E. Athanasopoulos, H. Bos, and G. Portokalidis, “Out of control: Overcoming control-flow integrity,” in IEEE Symposium on Security and Privacy, 2014.
[83] I. Heo, M. Kim, Y. Lee, J. Lee, B. B. Kang, and Y. Paek, “Implementing an application specific instruction-set processor for system level dynamic program analysis engines,” ACM Transactions on Design Automation of Electronic Systems, vol. 9, p. Article 39, March 2015.
[84] S. Fytraki, E. Vlachos, Y. O. Kocberber, B. Falsafi, and B. Grot, “FADE: A programmable filtering accelerator for instruction-grain monitoring,” in 20th IEEE International Symposium on High Performance Computer Architecture, HPCA 2014, Orlando, Fla., USA, Feb. 15-19, 2014, pp. 108-119, 2014.
[85] S. Nagarakatte, J. Zhao, M. M. K. Martin, and S. Zdancewic, “SoftBound: highly compatible and complete spatial memory safety for C,” in ACM SIGPLAN Conference on Programming Language Design and Implementation (PLDI), pp. 245-258, ACM, 2009.
[86] D. Arora, S. Ravi, A. Raghunathan, and N. K. Jha, “Architectural support for run-time validation of program data properties,” IEEE Transactions on Very Large Scale Integration (VLSI) Systems, vol. 15, pp. 546-559, May 2007.
[87] S. Chen, M. Kozuch, T. Strigkos, B. Falsafi, P. B. Gibbons, T. C. Mowry, V. Ramachandran, O. Ruwase, M. P. Ryan, and E. Vlachos, “Flexible hardware acceleration for instruction-grain program monitoring,” in 35th International Symposium on Computer Architecture (ISCA), pp. 377-388, IEEE, 2008.
[88] J. A. Clause, I. Doudalis, A. Orso, and M. Prvulovic, “Effective memory protection using dynamic tainting,” in 22nd IEEE/ACM International Conference on Automated Software Engineering (ASE), pp. 284-292, ACM, 2007.
[89] R. Wahbe, S. Lucco, T. E. Anderson, and S. L. Graham, “Efficient software-based fault isolation,” in Proceedings of the Symposium on Operating Systems Principles, SOSP, pp. 203-216, 1993.
[90] D. A. Huffman, “A method for the construction of minimum redundancy codes,” Proceedings of the IRE, vol. 40, pp. 1098-1101, 1952.
Achermann, Reto, Chris Dalton, Paolo Faraboschi, Moritz Hoffmann, Dejan Milojicic, Geoffrey Ndu, Alexander Richardson, Timothy Roscoe, Adrian L. Shaw, and Robert NM Watson. “Separating Translation from Protection in Address Spaces with Dynamic Remapping.” In Proceedings of the 16th Workshop on Hot Topics in Operating Systems, pp. 118-124. ACM, 2017.
Aga, Shaizeen, and Satish Narayanasamy. “InvisiMem: Smart memory defenses for memory bus side channel.” In ACM SIGARCH Computer Architecture News, vol. 45, no. 2, pp. 94-106. ACM, 2017.
Air Force Research Laboratory Report No. AFRL-RI-RS-TR-2015-210, Security-Tagged Architecture Co-Design (STACD), September 2015.
Anderson, Scan Noble, Roberto Blanco, Leonidas Lampropoulos, Benjamin C. Pierce, and Andrew Tolmach. “Formalizing Stack Safety as a Security Property.” In 2023 IEEE 36th Computer Security Foundations Symposium (CSF), pp. 356-371. IEEE, 2023.
Arora, D., Ravi, S., Raghunathan, A., and Jha, N. K. “Hardware-assisted run-time monitoring for secure program execution on embedded processors.” IEEE Transactions on Very Large Scale Integration (VLSI) Systems 14, no. 12 (2006): 1295-1308.
Arora, Divya, Srivaths Ravi, Anand Raghunathan, and Niraj K. Jha. “Secure embedded processing through hardware-assisted run-time monitoring.” In Design, Automation and Test in Europe, 2005. Proceedings, pp. 178-183. IEEE, 2005.
Belay, Adam, Andrea Bittau, Ali Josć Mashtizadeh, David Terei, David Mazières, and Christos Kozyrakis. “Dune: Safe User-level Access to Privileged CPU Features.” In Osdi, vol. 12, pp. 335-348. 2012.
Chen, Chun-Chung, Shih-Hao Hung, and Chen-Pang Lec. “Protection against Buffer Overflow Attacks via Dynamic Binary Translation.” In Reliable and Autonomous Computational Science, pp. 305-324. Springer, Basel, 2011.
Cheng, B.-C., and W.-M. Hwu, “Modular Interprocedural Pointer Analysis using Access Paths: Design, Implementation, and Evaluation”, in ACM SIGPLAN Notices 35, no. 5 (2000), pp. 57-69.
Chien, Andrew A., and Jay H. Byun. “Safe and protected execution for the morph/AMRM reconfigurable processor.” In Field-Programmable Custom Computing Machines, 1999. FCCM′99. Proceedings. Seventh Annual IEEE Symposium on, pp. 209-221. IEEE, 1999.
Choi, J.-D., M. Burke, and P. Carini. “Efficient Flow-sensitive Interprocedural Computation of Pointer-induced Aliases and Side effects”, in Proceedings of the 20th ACM SIGPLAN-SIGACT symposium on Principles of programming languages, pp. 232-245, 1993.
Corliss, Marc L., E. Christopher Lewis, and Amir Roth. “DISE: A programmable macro engine for customizing applications.” In Computer Architecture, 2003. Proceedings. 30th Annual International Symposium on, pp. 362-373. IEEE, 2003.
Costan, V, Ilia Lebedev, and Srinivas Devadas, “Sanctum: Minimal Hardware Extensions for Strong Software Isolation”, in Proceedings of the 25th Usenix Security Symposium, 2016, pp. 857-874.
Costan, V. and Srinivas Devadas, “Intel SGX Explained”, Cryptology ePrint Archive, Report 2016/086, February 2016.
Cox, Benjamin, David Evans, Adrian Filipi, Jonathan Rowanhill, Wei Hu, Jack Davidson, John Knight, Anh Nguyen-Tuong, and Jason Hiser. “15th USENIX Security Symposium.”
Crandall, J. R. and F. T. Chong, “MINOS: Control Data Attack Prevention Orthogonal to Memory Model”, in Proceedings of the 37th Intl. Symposium on Microarchitecture, Portland, OR, December 2004.
Dagit, Jason, Simon Winwood, Jem Berkes, and Adam Wick. “Code re-use attacks and their mitigation.” (2017).
Dalton, M., H. Kannan, and C. Kozyrakis, “Raksha: A Flexible Information Flow Architecture for Software Security”, in Proceedings of the International Symposium on Computer Architecture (ISCA), pp. 482-493, 2007.
De Moura, L., and N. Bjørner, “Z3: An efficient SMT solver”, in Proceedings of International conference on Tools and Algorithms for the Construction and Analysis of Systems, pp. 337-340, 2008.
Emami, M., R. Ghiya, and L. J. Hendren. “Context-Sensitive Interprocedural Points-to Analysis in the Presence of Function Pointers, in ACM SIGPLAN Notices, vol. 29, no. 6, pp. 242-256, 1994.
Evtyushkin, D. E., J. Elwell, M. Ozsoy, D. Ponomarev, N. Abu-Ghazalch and R. Riley, “Iso-X: A Flexible Architecture for Hardware-Managed Isolated Execution”, in Proceedings of the 47-th Annual Symposium on Microarchitecture (MICRO), (2014), pp. 190-202. IEEE.
Fahndrich, M., J. S. Foster, Z. Su, and A. Aiken, “Partial Online Cycle Elimination in Inclusion Constraint Graphs”, in Proceedings Proceedings of the ACM SIGPLAN Conference on Programming Language Design and Implementation (PLDI '98), pp. 85-96, 1998.
Ferraiuolo, Andrew, Mark Zhao, Andrew C. Myers, and G. Edward Suh. “HyperFlow: A processor architecture for nonmalleable, timing-safe information flow security.” In Proceedings of the 2018 ACM SIGSAC Conference on Computer and Communications Security, pp. 1583-1600. ACM, 2018.
Ferraiuolo, Andrew, Yuqi Zhao, G. Edward Suh, and Andrew C. Myers. HyperFlow: A Processor Architecture for Timing-Safe Information-Flow Security. 2018.
Feustel, Edward A, “On the Advantages of Tagged Architectures”, in IEEE Transactions on Computers, Vol. 22 (7), pp. 644-652, July 1973.
Fu, Jianming, Rui Jin, and Yan Lin. “FRProtector: Defeating Control Flow Hijacking Through Function-Level Randomization and Transfer Protection.” In International Conference on Security and Privacy in Communication Systems, pp. 659-672. Springer, Cham, 2017.
Ghose K. and P. Vasek, “A Fast Capability Extension to a RISC Architecture”, in Proceedings of the EUROMICRO Conference, September 1996, pp. 606-614.
Ghose, K. and M. B. Kamble, “Reducing Power in Superscalar Processor Caches using Subbanking, Multiple Line Buffers and Bit-line segmentation”, in Proceedings of the 1999 international symposium on Low Power Electronics and Design (ISLPED '99), pp. 70-75, 1999.
González, Julián A. “Hardware Modifications to Prevent Code Reuse Attacks.” (2014).
Graham, B, Protection in an Information Processing Utility, in Communications of the ACM, Volume 11, pp. 306-312, May 1968.
Halfond, W. G. J., and A. Orso, “AMNESIA: Analysis and Monitoring for NEutralizing SQL-Injection Attacks”, in Proceedings of the 20th IEEE/ACM international Conference on Automated Software Engineering (ASE '05), pp. 174-183, 2005.
Hardekopf, B., and C. Lin, “The Ant and the Grasshopper: Fast and Accurate Pointer Analysis for Millions of Lines of Code”, in ACM SIGPLAN Notices, vol. 42, no. 6, pp. 290-299, 2007.
Havet, Aurelien, Rafael Pires, Pascal Felber, Marcelo Pasin, Romain Rouvoy, and Valerio Schiavoni. “SecureStreams: A Reactive Middleware Framework for Secure Data Stream Processing.” In Proceedings of the 11th ACM International Conference on Distributed and Event-based Systems, pp. 124-133. ACM, 2017.
Heintze, N., and O. Tardieu, “Ultra-fast Aliasing Analysis using CLA: A Million Lines of C Code in a Second”, in ACM SIGPLAN Notices, vol. 36, no. 5, pp. 254-263, 2001.
Hoefler, Torsten, Salvatore Di Girolamo, Konstantin Taranov, Ryan E. Grant, and Ron Brightwell. “sPIN: High-performance streaming Processing in the Network.” In Proceedings of the International Conference for High Performance Computing, Networking, Storage and Analysis, p. 59. ACM, 2017.
Houdek, M. E., F. G. Soltis, and R. L. Hoffman, “IBM System/38 Support for Capability-based Addressing”, in Proceedings of the Eighth Annual Symposium on Computer Architecture, pp. 341-348, 1981.
Hund R., T. Holz and F. Freiling, “Return oriented rootkits: Bypassing kernel code integrity protection mechanisms”, in Proc. of Usenix Security Symposium, pp. 383-398, 2009.
Intel Corporation, Control-flow Enforcement Technology Preview, Document Number: 334525-001, June 2016.
Intel Corporation, Introduction to the iAPX 432 Architecture, Manual No. 171821-001, 1981.
Intel Corporation., Intel Memory Protection Extensions Enabling Guide, software.intel.com/sites/default/files/managed/9d/f6/Intel_MPX_EnablingGuide.pdf Accessed: 2017 May 30.
Jero, Samuel, Nathan Burow, Bryan Ward, Richard Skowyra, Roger Khazan, Howard Shrobe, and Hamed Okhravi. “Tag: Tagged architecture guide.” ACM Computing Surveys 55, no. 6 (2022): 1-34.
Joannou, Alexandre, Jonathan Woodruff, Robert Kovacsics, Simon W. Moore, Alex Bradbury, Hongyan Xia, Robert NM Watson et al. “Efficient Tagged Memory.” In Computer Design (ICCD), 2017 IEEE International Conference on, pp. 641-648. IEEE, 2017.
Jungwirth, Patrick, Phil Chan, Eric Imsand, and Hameed Badawy. “Security tag computation and propagation in OSFA.” In Cyber Sensing 2018, vol. 10630, p. 1063004. International Society for Optics and Photonics, 2018.
Jungwirth, Patrick, Philip Chan, Thomas Barnett, and Abdel-Hameed Badawy. “Cyber defense through hardware security.” In Disruptive Technologies in Information Sciences, vol. 10652, p. 106520P. International Society for Optics and Photonics, 2018.
Kannan, Hari, Michael Dalton, and Christos Kozyrakis. “Decoupling dynamic information flow tracking with a dedicated coprocessor.” In Dependable Systems & Networks, 2009. DSN′09. IEEE/IFIP International Conference on, pp. 105-114. IEEE, 2009.
Kayaalp M., Ozsoy M., Abu-Ghazalch N., Ponomarev D., “Branch Regulation: Low Overhead Protection Fron Code Reuse Attacks”, 39th Int'l. Symp. on Computer Architecture (ISCA), pp. 94-105, 2012.
Kim, Channoh, Jachycok Kim, Sungmin Kim, Dooyoung Kim, Namho Kim, Gitac Na, Young H. Oh, Hycon Gyu Cho, and Jae W. Lee. “Typed Architectures: Architectural Support for Lightweight Scripting.” ACM SIGOPS Operating Systems Review 51, no. 2 (2017): 77-90.
Landi, W., and B. G. Ryder. “A Safe Approximate Algorithm for Interprocedural Pointer Aliasing”, ACM SIGPLAN Notices 39, no. 4 (2004), pp. 473-489.
Lentz, Matthew, Rijurekha Sen, Peter Druschel, and Bobby Bhattacharjec. “ScCloak: ARM Trustzone-based Mobile Peripheral Control.” (2018).
Levy, H. M., Capability-Based Computer Systems, Digital Press, 1984.
Lic, David, Chandramohan Thekkath, Mark Mitchell, Patrick Lincoln, Dan Bonch, John Mitchell, and Mark Horowitz. “Architectural support for copy and tamper resistant software.” ACM SIGPLAN Notices 35, no. 11 (2000): 168-177.
Liu, Tao, Hui Guo, Sri Parameswaran, and Sharon X. Hu. “iCETD: An improved tag generation design for memory data authentication in embedded processor systems.” Integration, the VLSI Journal 56 (2017): 96-104.
Liu, Tong, Gang Shi, Liwei Chen, Fei Zhang, Yaxuan Yang, and Jihu Zhang. “TMDFI: Tagged Memory Assisted for Fine-Grained Data-Flow Integrity Towards Embedded Systems Against Software Exploitation.” In 2018 17th IEEE International Conference On Trust, Security And Privacy In Computing And Communications/12th IEEE International Conference On Big Data Science And Engineering (TrustCom/BigDataSE), pp. 545-550. IEEE, 2018.
McKeen, F., I. Alexandrovich, A. Berenzon, C. Rozas, H. Shafi, V. Shanbhogue, and U. R. Savagaonkar, “Innovative Instructions and Software Model for Isolated Execution”, in Proceedings of the Workshop on Hardware and Architectural Support for Security and Privacy (HASP), pp. 10:1-10:8, 2013.
Moon, D. A., “Architecture of the Symbolics 3600”, in Proceedings of the 12th. Annual International Symposium on Computer Architecture, ISCA, pp. 76-83, 1985. IEEE Computer Society.
Nienhuis, Kyndylan, Alexandre Joannou, Thomas Bauereiss, Anthony Fox, Michael Roc, Brian Campbell, Matthew Naylor et al. “Rigorous engineering for hardware security: Formal modelling and proof in the CHERI design and implementation process.” In 2020 IEEE Symposium on Security and Privacy (SP), pp. 1003-1020. IEEE, 2020.
Nystrom, Erik, Hong-Seok Kim, and Wen-Mei Hwu. “Bottom-up and Top-down Context-sensitive Summary-based Pointer Analysis.” Static Analysis, pp. 165-180, 2004.
Organick, E. I, Computer System Organization: The B5700/B6700 Series, Academic Press, 1973.
Pietraszek, T. and C. V. Berghe, “Defending Against Injection Attacks through Context-Sensitive String Evaluation”, in Proceedings of the Recent Advances in Intrusion Detection Symposium, Seattle, WA, September 2005.
Qin, F., C. Wang, Z. Li, H. Seop Kim, Y. Zhou, and Y. Wu, “LIFT: A Low-Overhead Practical Information Flow Tracking System for Detecting Security Attacks”, in Proceedings of the 39th the Intl. Symposium on Microarchitecture, Orlando, F L, December 2006.
Reddy, A L Narasimha, and Prithviraj Banerjee. “A fault secure dictionary machine.” In Data Engineering, 1987 IEEE Third International Conference on, pp. 104-110. IEEE, 1987.
Shioya, R., D. Kim, K. Horio, M. Goshima, and S. Sakai, Low-overhead Architecture for Security Tag, in Proceedings of the 2009 15th IEEE Pacific Rim International Symposium on Dependable DComputing, PRDC '09, pages 135-142, Washington, DC, USA, 2009. IEEE Computer Society.
Shioya, Ryota, Daewung Kim, Kazuo Horio, Masahiro Goshima, and Shuichi Sakai. “Low-overhead architecture for security tag.” IEICE TRANSACTIONS on Information and Systems 94, no. 1 (2011): 69-78.
Skorstengaard, Lau, Dominique Devriese, and Lars Birkedal. “Enforcing well-bracketed control flow and stack encapsulation using linear capabilities.” In PriSC 2018 Principles of Secure Compilation. 2018.
Sui, Y., and J. Xuc. “SVF: Interprocedural Static Value-flow Analysis in LLVM”, in Proceedings of the 25th ACM International Conference on Compiler Construction, pp. 265-266, 2016.
Sullivan, G., “The Dover Architecture”, presentation at New England Security Day, Nov. 28, 2016
Tiwari, Mohit, Banit Agrawal, Shashidhar Mysore, Jonathan Valamehr, and Timothy Sherwood. “A small cache of large ranges: Hardware methods for efficiently searching, storing, and updating big dataflow tags.” In Proceedings of the 41st annual IEEE/ACM International Symposium on Microarchitecture, pp. 94-105. IEEE Computer Society, 2008.
Vasek, P. and K. Ghose, “A Comparison of Two Context Allocation Approaches for Fast Protected Calls”, in Proceedings of the IEEE Conference on High-Performance Computing (HiPC), December 1997, pp. 16-21.
Watson, Robert Nicholas, Peter G. Neumann, and Simon W. Moore. “Balancing Disruption and Deployability in the CHERI Instruction-Set Architecture (ISA).” MIT Press, 2017.
Watson, Robert NM, Jonathan Woodruff, Michael Roc, Simon W. Moore, and Peter G. Neumann. Capability Hardware Enhanced RISC Instructions (CHERI): Notes on the Meltdown and Spectre Attacks. No. UCAM-CL-TR-916. University of Cambridge, Computer Laboratory, 2018.
Whaley, J., and M. S. Lam. “Cloning-based Context-Sensitive Pointer Alias Analysis Using Binary Decision Diagrams”, in ACM SIGPLAN Notices, vol. 39, no. 6, pp. 131-144, 2004.
Wilkerson, Christopher B. “System and method to bypass execution of instructions involving unreliable data during speculative execution.” U.S. Pat. No. 7,114,059, issued Sep. 26, 2006.
Witchel, E., J. Cates, and K. Asanovic, “Mondrian Memory Protection”, in Proceedings of the 10th International Conference on Architectural Support for Programming Languages and Operating Systems, ASPLOS X, Vol. 37, no. 10. pp. 304-316, New York, NY, USA, 2002. ACM.
Wong, Ming Ming, Jawad Haj-Yahya, and Anupam Chattopadhyay. “SMARTS: secure memory assurance of RISC-V trusted SoC.” In Proceedings of the 7th International Workshop on Hardware and Architectural Support for Security and Privacy, p. 6. ACM, 2018.
Woodruff, Jonathan David, A. Joannou, Robert Kovacsics, Simon William Moore, A. Bradbury, H. Xia, R. N. M. Robert et al. “Efficient Tagged Memory.” (2018).
Wulf, W. A., S. P. Levin and S. P. Harbison, Hydra/Cmmp: An Experimental Computer System, McGraw-Hill, 1981.
Xu, W., S. Bhatkar, and R. Sekar, “Taint-enhanced Policy Enforcement: A Practical Approach to Defeat a Wide Range of Attacks”, in Proceedings of the 15th USENIX Security Conference, Vancouver, Canada, August 2006.
Yang, L. I., and Jun-wei LI. “A Technique Preventing Code Reuse Attacks Based on RISC Processor.” DEStech Transactions on Computer Science and Engineering CCNT (2018).
Yao, Zhihao, Saced Mirzamohammadi, Ardalan Amiri Sani, and Mathias Payer. “Milkomeda: Safeguarding the Mobile GPU Interface Using WebGL Security Checks.” In Proceedings of the 2018 ACM SIGSAC Conference on Computer and Communications Security, pp. 1455-1469. ACM, 2018.
Zeldovich, Nickolai, Hari Kannan, Michael Dalton, and Christos Kozyrakis. “Hardware Enforcement of Application Security Policies Using Tagged Memory.” In OSDI, vol. 8, pp. 225-240. 2008.
Zeldovich, Nickolai, Silas Boyd-Wickizer, Eddie Kohler, and David Mazières. “Making information flow explicit in HiStar.” In Proceedings of the 7th symposium on Operating systems design and implementation, pp. 263-278. USENIX Association, 2006.
Zhu, J., “Towards Scalable Flow and Context Sensitive Pointer Analysis”, in Proceedings of the 42nd annual Design Automation Conference, pp. 831-836, 2005.
U.S. Patent and Patent Application Nos. RE34052; RE35311; 3349375; 3396371; 3418638; 3425039; 3449724; 3462744; 3611314; 3618045; 3956615; 3979726; 4156906; 4179736; 4189768; 4189770; 4189772; 4212058; 4415970; 4471432; 4566062; 4630195; 4686513; 4744049; 4745574; 4751638; 4775927; 4807115; 4873633; 4882673; 4887203; 4887235; 4922414; 4943916; 4953073; 5043870; 5051940; 5095424; 5136696; 5142634; 5146570; 5150470; 5168560; 5197135; 5201056; 5204840; 5208914; 5210838; 5210843; 5214763; 5226130; 5226146; 5247357; 5247625; 5249281; 5249286; 5295249; 5301298; 5303356; 5319766; 5325464; 5329611; 5341506; 5355460; 5361267; 5367660; 5379396; 5381544; 5386547; 5388224; 5392391; 5398321; 5404470; 5410685; 5412787; 5426771; 5430884; 5440707; 5442756; 5448746; 5450560; 5450565; 5471593; 5479641; 5483620; 5493667; 5497499; 5502826; 5504932; 5517596; 5519841; 5522051; 5526296; 5537562; 5544337; 5548735; 5553258; 5553266; 5555382; 5555432; 5560028; 5564118; 5581719; 5586296; 5590294; 5590295; 5598547; 5603005; 5604909; 5604912; 5606313; 5606683; 5613087; 5619662; 5623614; 5623627; 5623650; 5627517; 5628021; 5629950; 5630157; 5632023; 5644742; 5649137; 5649225; 5651125; 5655096; 5664215; 5680571; 5682491; 5682544; 5687110; 5692167; 5692168; 5701425; 5701435; 5701508; 5706491; 5713039; 5717896; 5717898; 5721945; 5727177; 5732243; 5732253; 5737750; 5740416; 5742791; 5742802; 5745725; 5752069; 5752259; 5752263; 5754878; 5764946; 5768170; 5768575; 5768610; 5774710; 5774876; 5778408; 5781753; 5781789; 5781792; 5784587; 5784640; 5790824; 5793941; 5794068; 5799172; 5802337; 5802338; 5802373; 5804810; 5805490; 5805849; 5805851; 5809322; 5819057; 5819059; 5822556; 5822558; 5822559; 5822574; 5822755; 5826013; 5826055; 5826070; 5826071; 5828873; 5829028; 5829031; 5832249; 5832297; 5835712; 5835745; 5835748; 5835754; 5835951; 5835967; 5838940; 5841999; 5842017; 5848433; 5850543; 5852726; 5854921; 5857096; 5859991; 5859998; 5860093; 5860104; 5860158; 5864341; 5864689; 5864707; 5870575; 5870579; 5870582; 5872950; 5872951; 5875201; 5875315; 5875324; 5875326; 5878242; 5878244; 5878255; 5881278; 5881305; 5887152; 5887161; 5892441; 5892934; 5892936; 5895497; 5898849; 5898851; 5898865; 5901302; 5901308; 5903740; 5903741; 5911083; 5915110; 5915262; 5919256; 5920710; 5926646; 5930489; 5930490; 5930509; 5930820; 5930832; 5933618; 5933850; 5938761; 5940334; 5940602; 5940859; 5940876; 5941981; 5944811; 5944815; 5944818; 5946468; 5951679; 5953520; 5956494; 5956495; 5958043; 5958045; 5958072; 5959568; 5964884; 5966734; 5968162; 5968169; 5974522; 5974543; 5983325; 5983336; 5983342; 5983351; 5987480; 5987561; 5991279; 5991389; 5995743; 6000028; 6002344; 6006242; 6006324; 6012134; 6028924; 6029146; 6029204; 6029228; 6032244; 6032247; 6032252; 6038309; 6041396; 6046683; 6047363; 6055650; 6058447; 6067644; 6073230; 6076151; 6076156; 6079003; 6079005; 6084454; 6084530; 6085314; 6091897; 6092094; 6098150; 6098167; 6101577; 6101597; 6108769; 6108770; 6112019; 6119206; 6119222; 6128720; 6131157; 6150921; 6151662; 6157995; 6161167; 6163839; 6170053; 6178545; 6192461; 6202139; 6211781; 6212603; 6212621; 6226707; 6236315; 6237082; 6266744; 6272453; 6282629; 6289442; 6289444; 6295601; 6304962; 6343359; 6353406; 6374334; 6385719; 6393536; 6393551; 6408379; 6415360; 6415378; 6426755; 6427193; 6434738; 6438655; 6442677; 6442707; 6446029; 6449736; 6456668; 6463523; 6472976; 6473832; 6473837; 6473850; 6493819; 6496922; 6502188; 6535972; 6542986; 6543002; 6549986; 6553480; 6594728; 6604190; 6615300; 6654869; 6658578; 6662280; 6677852; 6681319; 6691308; 6725014; 6725354; 6728872; 6742108; 6772322; 6772375; 6772383; 6775283; 6792523; 6804770; 6812824; 6813704; 6883090; 6892293; 6901500; 6903656; 6956576; 6973417; 7007105; 7043668; 7055070; 7058793; 7065635; 7069544; 7082436; 7086035; 7089400; 7124072; 7132944; 7133400; 7134116; 7146422; 7149982; 7168066; 7171689; 7177817; 7178133; 7181728; 7194769; 7219239; 7231551; 7254586; 7275149; 7284239; 7287029; 7346741; 7346922; 7353445; 7376969; 7383403; 7401209; 7401310; 7418576; 7428699; 7434000; 7434004; 7434031; 7451488; 7464407; 7512711; 7523871; 7607169; 7636044; 7650638; 7673190; 7673345; 7693840; 7716455; 7735073; 7743421; 7752255; 7752459; 7761917; 7761918; 7768392; 7788722; 7831811; 7844505; 7861299; 7926113; 7958549; 7962961; 7987271; 7996632; 8028341; 8037250; 8042054; 8055732; 8055797; 8056130; 8065725; 8095984; 8111141; 8115632; 8127359; 8131787; 8141155; 8145725; 8161540; 8176001; 8176527; 8185820; 8201257; 8209753; 8224930; 8230507; 8234711; 8281036; 8296848; 8301870; 8306228; 8315944; 8316448; 8332367; 8365278; 8365289; 8381192; 8392997; 8412354; 8422379; 8438532; 8438643; 8443030; 8458798; 8468606; 8474004; 8484741; 8516226; 8516594; 8521676; 8522131; 8522348; 8533843; 8544098; 8566928; 8572550; 8572750; 8578135; 8595845; 8601104; 8601530; 8602089; 8607336; 8611232; 8612936; 8613083; 8615431; 8615656; 8627402; 8631248; 8631489; 8639646; 8640240; 8644516; 8650637; 8669872; 8698629; 8730946; 8732105; 8732106; 8762188; 8776180; 8789192; 8789193; 8813235; 8819420; 8824748; 8826438; 8830064; 8830065; 8844043; 8844045; 8850588; 8856120; 8856936; 8869110; 8874685; 8893283; 8903705; 8909903; 8914388; 8918884; 8918887; 8925082; 8943273; 8943313; 8949169; 8954369; 8966619; 8966639; 8983926; 8984579; 8984643; 8990948; 8997103; 9003537; 9027125; 9032533; 9043753; 9043920; 9047293; 9069930; 9081779; 9092616; 9094448; 9104923; 9118706; 9127946; 9128801; 9141378; 9141805; 9158871; 9160761; 9165133; 9166994; 9178911; 9219787; 9224117; 9244908; 9256746; 9268945; 9270695; 9276951; 9280148; 9280683; 9286196; 9292695; 9298923; 9305165; 9306969; 9306975; 9317692; 9317708; 9319425; 9323921; 9325617; 9325729; 9336185; 9361086; 9369482; 9372995; 9389933; 9392007; 9400685; 9407645; 9411965; 9413538; 9425965; 9456004; 9467464; 9467465; 9473529; 9477478; 9479535; 9495183; 9503467; 9507855; 9516058; 9524171; 9537876; 9537884; 9544326; 9553918; 9588803; 9594563; 9602529; 9614864; 9619655; 9628109; 9628501; 9633213; 9635033; 9648036; 9652536; 9665721; 9679063; 9680699; 9680861; 9686291; 9690583; 9692778; 9692779; 9716721; 9722803; 9726460; 9727736; 9729568; 9762617; 9779063; 9779191; 9792438; 9792472; 9798702; 9798873; 9817978; 9825981; 9825982; 9846780; 9860265; 9866426; 9871815; 9881271; 9886303; 9886581; 9886582; 9887886; 9894088; 9898739; 9900339; 9912683; 9923916; 9923917; 9928369; 9930065; 9984098; 10028105; 10055644; 10122666; 10222279; 10231078; 10235176; 10270607; 10282695; 10282696; 10303187; 10311042; 10402435; 10405790; 10482421; 10484833; 10501267; 10628286; 10643174; 10664538; 10685326; 10691457; 10691639; 10724895; 10754650; 10831492; 10853469; 10893382; 10929141; 10936713; 10979333; 11042692; 11081106; 11086630; 11150910; 11164121; 11182338; 11194764; 11198088; 11232208; 11263151; 11385891; 11402971; 11416946; 11449923; 11467841; 11481368; 11487667; 11487730; 11507659; 11512576; 11513801; 11514229; 11526801; 11527172; 11533357; 11537402; 11537653; 11537985; 11544285; 11544519; 11561794; 11562380; 11570273; 11574002; 11574324; 11580069; 11580264; 11580735; 11586542; 11595934; 11615618; 11741196; 20010011346; 20010012267; 20010040513; 20020004897; 20020005774; 20020023201; 20020032709; 20020032831; 20020032849; 20020040429; 20020051536; 20020052798; 20020053038; 20020054138; 20020059586; 20020066020; 20020073302; 20020075145; 20020083304; 20020087821; 20020089956; 20020091696; 20020091892; 20020091996; 20020097623; 20020103971; 20020113709; 20020116567; 20020124162; 20020126005; 20020143803; 20020144092; 20020154639; 20020156996; 20020169947; 20020199091; 20030023699; 20030030568; 20030061465; 20030061467; 20030061470; 20030069907; 20030069975; 20030074543; 20030088759; 20030090712; 20030142526; 20030154359; 20030154463; 20030159009; 20030159020; 20030167406; 20030172252; 20030182537; 20030182540; 20030182572; 20030183697; 20030188129; 20030188130; 20030188131; 20030188133; 20030188140; 20030196077; 20030208672; 20030214389; 20030216923; 20030221091; 20040002943; 20040003214; 20040003278; 20040020636; 20040020643; 20040024968; 20040039896; 20040044848; 20040044878; 20040044880; 20040064682; 20040078559; 20040083479; 20040088489; 20040111338; 20040143721; 20040143730; 20040151203; 20040153586; 20040162972; 20040172521; 20040172557; 20040181654; 20040193808; 20040193823; 20040193936; 20040194097; 20040196842; 20040199472; 20040199604; 20040199667; 20040199749; 20040205589; 20040210743; 20040215897; 20040215898; 20040215933; 20040215936; 20040218762; 20040221138; 20040225416; 20040230660; 20040243739; 20040254948; 20050005169; 20050010821; 20050015552; 20050027975; 20050038536; 20050038633; 20050039071; 20050039108; 20050039119; 20050055541; 20050097542; 20050108495; 20050120193; 20050138413; 20050138607; 20050149521; 20050174235; 20050177707; 20050187958; 20050187963; 20050188179; 20050188276; 20050222707; 20050229255; 20050234778; 20050258932; 20050258962; 20050268040; 20060015632; 20060022802; 20060031157; 20060069873; 20060069912; 20060095674; 20060106986; 20060112268; 20060129628; 20060149981; 20060150076; 20060150111; 20060153579; 20060174096; 20060179346; 20060179429; 20060184771; 20060184776; 20060190703; 20060197838; 20060200615; 20060200686; 20060225135; 20060253776; 20060259726; 20060259741; 20060259828; 20060259859; 20060261952; 20060261953; 20060261954; 20060261955; 20060261956; 20060265225; 20060265324; 20060265573; 20060265751; 20060271820; 20060282409; 20070008759; 20070008916; 20070011323; 20070011516; 20070026919; 20070028077; 20070028151; 20070041403; 20070043846; 20070043936; 20070050610; 20070061874; 20070061885; 20070067571; 20070067846; 20070067847; 20070067848; 20070071028; 20070075898; 20070079018; 20070094475; 20070101110; 20070101111; 20070113050; 20070139199; 20070143853; 20070150659; 20070150675; 20070150676; 20070156448; 20070162709; 20070162890; 20070169199; 20070174553; 20070177615; 20070192866; 20070192867; 20070194882; 20070204135; 20070204137; 20070214094; 20070226472; 20070239938; 20070250666; 20070252691; 20070256050; 20070274626; 20070288730; 20070288731; 20070288732; 20070288733; 20070288734; 20070288736; 20070294623; 20080005784; 20080010441; 20080016324; 20080022263; 20080028152; 20080028196; 20080028302; 20080040657; 20080060077; 20080068381; 20080071793; 20080071826; 20080071871; 20080071888; 20080071889; 20080071891; 20080071896; 20080071898; 20080072018; 20080072032; 20080072241; 20080072277; 20080072278; 20080074433; 20080077909; 20080089521; 20080092237; 20080094220; 20080101106; 20080101387; 20080109306; 20080109637; 20080127293; 20080127349; 20080140705; 20080140996; 20080151692; 20080162903; 20080162905; 20080162908; 20080169914; 20080172739; 20080175488; 20080178157; 20080183757; 20080183976; 20080184018; 20080189535; 20080195850; 20080222395; 20080222724; 20080229425; 20080246675; 20080250275; 20080254740; 20080256638; 20080266055; 20080270104; 20080270750; 20080270833; 20080270890; 20080271018; 20080271019; 20080271025; 20080282051; 20080282339; 20080307210; 20080313739; 20080314570; 20080314980; 20090006473; 20090006536; 20090006811; 20090007269; 20090019306; 20090021343; 20090028135; 20090034784; 20090037257; 20090037409; 20090049286; 20090058599; 20090058730; 20090063823; 20090077666; 20090099885; 20090100077; 20090100206; 20090102660; 20090103524; 20090106042; 20090106318; 20090106499; 20090112596; 20090113550; 20090119485; 20090119493; 20090138275; 20090138682; 20090157291; 20090174531; 20090187740; 20090187741; 20090187742; 20090187743; 20090187744; 20090198900; 20090198962; 20090198981; 20090198982; 20090198985; 20090204591; 20090222626; 20090249033; 20090251289; 20090254993; 20090259827; 20090271772; 20090271790; 20090281864; 20090292960; 20090293100; 20090300327; 20090303006; 20090326953; 20100017580; 20100030966; 20100042824; 20100049727; 20100049912; 20100049953; 20100050266; 20100058033; 20100058035; 20100064307; 20100065625; 20100070841; 20100082119; 20100083237; 20100088444; 20100088771; 20100095235; 20100095381; 20100106945; 20100114895; 20100121817; 20100121839; 20100154066; 20100158204; 20100161508; 20100161945; 20100161948; 20100169622; 20100169625; 20100170352; 20100174692; 20100192228; 20100198940; 20100207737; 20100223612; 20100251016; 20100255870; 20100257341; 20100259719; 20100262807; 20100275263; 20100289627; 20100306851; 20100312989; 20100315203; 20100332790; 20100333098; 20110030057; 20110047369; 20110053491; 20110055805; 20110060809; 20110066829; 20110084834; 20110093500; 20110093779; 20110093954; 20110106519; 20110125548; 20110126119; 20110138469; 20110138471; 20110141877; 20110145258; 20110153621; 20110154000; 20110154123; 20110154298; 20110161641; 20110181311; 20110191854; 20110231936; 20110246909; 20110247038; 20110289519; 20110290260; 20110290262; 20110316676; 20110318013; 20110320785; 20110320786; 20110321002; 20110321003; 20110321021; 20120017166; 20120030559; 20120036346; 20120046897; 20120047382; 20120054143; 20120066587; 20120067594; 20120072488; 20120075076; 20120109953; 20120124347; 20120131536; 20120143927; 20120145589; 20120166836; 20120174236; 20120185734; 20120185945; 20120203590; 20120204261; 20120222123; 20120223817; 20120232679; 20120233407; 20120246103; 20120260306; 20120270571; 20120272205; 20120278595; 20120284221; 20120290817; 20120304299; 20120304300; 20120311534; 20120311715; 20120320151; 20130007423; 20130017872; 20130018920; 20130024676; 20130024725; 20130031364; 20130031465; 20130036314; 20130036464; 20130047155; 20130048721; 20130055394; 20130073833; 20130074038; 20130074188; 20130080733; 20130086688; 20130111137; 20130120612; 20130124311; 20130125204; 20130145129; 20130151419; 20130151955; 20130167240; 20130179685; 20130182561; 20130188879; 20130191808; 20130191919; 20130198633; 20130198846; 20130212585; 20130227221; 20130227698; 20130246333; 20130246609; 20130246709; 20130247206; 20130254304; 20130268253; 20130276136; 20130290480; 20130297375; 20130298192; 20130298230; 20130298242; 20130298243; 20130298244; 20130317919; 20130326469; 20130339671; 20130346730; 20140007061; 20140007241; 20140025894; 20140029616; 20140032505; 20140034719; 20140035732; 20140043163; 20140046922; 20140047545; 20140059683; 20140068267; 20140075158; 20140075414; 20140082733; 20140089598; 20140089902; 20140108573; 20140122845; 20140122846; 20140128039; 20140132291; 20140137257; 20140149726; 20140165204; 20140172495; 20140173192; 20140173731; 20140173737; 20140176665; 20140181975; 20140181976; 20140189787; 20140189873; 20140192181; 20140196154; 20140201843; 20140215614; 20140215629; 20140218389; 20140226035; 20140229713; 20140229866; 20140237545; 20140244933; 20140245376; 20140250429; 20140253975; 20140267239; 20140280148; 20140281246; 20140281410; 20140281431; 20140282546; 20140283083; 20140297886; 20140298105; 20140310341; 20140317677; 20140325551; 20140337971; 20140337974; 20140354401; 20140365442; 20140366145; 20140373160; 20140380023; 20150013007; 20150019227; 20150020211; 20150026436; 20150026685; 20150032841; 20150032985; 20150033340; 20150039855; 20150040220; 20150040228; 20150046651; 20150052334; 20150052339; 20150058993; 20150058997; 20150064685; 20150067323; 20150067762; 20150074353; 20150074377; 20150074378; 20150074379; 20150074381; 20150074680; 20150074787; 20150082006; 20150088733; 20150089141; 20150089180; 20150095980; 20150098616; 20150106602; 20150106604; 20150106746; 20150106873; 20150120858; 20150121050; 20150127686; 20150139235; 20150142828; 20150148058; 20150150085; 20150172307; 20150186472; 20150186654; 20150189151; 20150193348; 20150206447; 20150211318; 20150212820; 20150213358; 20150222655; 20150235164; 20150237062; 20150237065; 20150241139; 20150242307; 20150242637; 20150244734; 20150244735; 20150245110; 20150245307; 20150277925; 20150288712; 20150295948; 20150295988; 20150301515; 20150304337; 20150310217; 20150312117; 20150312118; 20150317100; 20150319127; 20150330790; 20150332408; 20150332409; 20150332518; 20150347133; 20150347134; 20150347137; 20150347152; 20150355308; 20150363614; 20150365558; 20150378739; 20150378912; 20150378915; 20160006735; 20160012236; 20160026832; 20160034682; 20160035048; 20160041975; 20160048602; 20160048848; 20160057164; 20160057790; 20160063248; 20160063249; 20160063250; 20160063251; 20160063252; 20160065598; 20160072835; 20160078377; 20160092361; 20160105455; 20160117174; 20160119373; 20160132538; 20160134484; 20160140042; 20160140363; 20160170751; 20160170752; 20160170753; 20160170754; 20160170755; 20160170756; 20160170757; 20160170758; 20160170759; 20160170760; 20160170761; 20160170762; 20160170763; 20160170764; 20160170766; 20160170878; 20160173531; 20160179416; 20160180080; 20160180672; 20160180674; 20160188882; 20160191361; 20160202983; 20160205122; 20160210142; 20160212153; 20160224349; 20160225187; 20160232358; 20160234065; 20160239308; 20160248794; 20160248796; 20160253161; 20160253177; 20160253180; 20160253181; 20160253590; 20160259944; 20160259956; 20160261640; 20160269435; 20160283236; 20160283536; 20160283712; 20160292021; 20160323706; 20160328330; 20160337484; 20160342414; 20160342420; 20160342581; 20160344746; 20160349825; 20160350118; 20160350119; 20160350120; 20160350121; 20160350122; 20160350123; 20160350126; 20160350127; 20160357567; 20160357568; 20160366174; 20160371091; 20160371188; 20160378504; 20160378565; 20160378994; 20170003971; 20170010970; 20170026401; 20170034023; 20170034089; 20170034200; 20170046519; 20170053115; 20170060579; 20170061060; 20170061133; 20170078322; 20170083916; 20170090934; 20170090935; 20170090941; 20170091465; 20170093910; 20170097851; 20170103510; 20170109093; 20170109166; 20170109167; 20170109168; 20170109171; 20170109172; 20170116302; 20170124258; 20170132140; 20170134298; 20170142138; 20170149786; 20170149816; 20170168940; 20170169217; 20170171236; 20170177272; 20170177367; 20170177368; 20170178111; 20170178121; 20170180411; 20170180593; 20170185410; 20170185459; 20170192996; 20170193239; 20170200217; 20170206153; 20170206381; 20170208084; 20170208085; 20170208093; 20170212844; 20170213002; 20170213057; 20170214117; 20170214708; 20170214710; 20170215038; 20170235674; 20170235810; 20170243009; 20170250938; 20170250998; 20170262382; 20170262655; 20170270326; 20170277535; 20170277541; 20170285602; 20170286202; 20170286690; 20170289187; 20170293489; 20170293563; 20170295181; 20170295197; 20170300911; 20170315528; 20170315809; 20170315810; 20170316213; 20170316488; 20170318048; 20170324763; 20170324766; 20170327142; 20170328791; 20170329608; 20170329715; 20170329975; 20170331682; 20170344366; 20170344367; 20170344368; 20170344379; 20170344380; 20170344469; 20170344480; 20170344637; 20170346847; 20170351226; 20170351522; 20170351568; 20170351583; 20170351600; 20170351610; 20170353313; 20170353482; 20170357513; 20170364356; 20170364358; 20180004516; 20180004527; 20180011708; 20180032733; 20180032736; 20180034840; 20180038037; 20180041539; 20180048668; 20180052835; 20180060073; 20180060867; 20180063171; 20180063172; 20180063177; 20180068701; 20180077156; 20180077188; 20180077193; 20180077195; 20180081541; 20180088564; 20180088566; 20180089305; 20180089569; 20180089870; 20180091539; 20180096609; 20180103054; 20180139565; 20180157602; 20180160649; 20180165096; 20180165199; 20180165200; 20180165210; 20180181488; 20180192104; 20180196860; 20180217844; 20180239604; 20180246718; 20180246723; 20180267516; 20180300142; 20180300143; 20180300149; 20180300150; 20180300151; 20180300152; 20180300153; 20180300156; 20180300157; 20180300158; 20180300159; 20180300233; 20180300368; 20180314523; 20180314570; 20180333244; 20180336037; 20180336108; 20180337958; 20180357180; 20180365151; 20190013003; 20190018844; 20190018869; 20190018870; 20190026819; 20190031146; 20190032353; 20190065314; 20190081989; 20190087184; 20190087194; 20190087195; 20190095107; 20190108025; 20190108026; 20190108027; 20190108028; 20190108031; 20190108033; 20190108034; 20190108035; 20190108133; 20190124475; 20190138767; 20190147367; 20190163480; 20190179641; 20190182315; 20190183399; 20190187992; 20190187993; 20190187995; 20190188133; 20190188140; 20190197193; 20190208798; 20190213322; 20190213462; 20190220279; 20190227806; 20190235761; 20190235873; 20190236677; 20190243655; 20190266060; 20190278797; 20190286857; 20190327144; 20190335715; 20190340053; 20190362616; 20190370421; 20190373940; 20190378019; 20190380311; 20190384607; 20200007388; 20200019405; 20200019488; 20200019499; 20200026520; 20200026521; 20200026891; 20200042155; 20200042319; 20200053568; 20200081716; 20200090661; 20200125770; 20200133880; 20200137983; 20200142697; 20200143123; 20200150638; 20200159564; 20200159888; 20200167166; 20200174903; 20200174907; 20200175162; 20200175402; 20200175865; 20200175972; 20200183700; 20200183701; 20200193559; 20200201639; 20200206087; 20200241931; 20200249954; 20200272736; 20200278868; 20200278887; 20200293328; 20200301710; 20200310814; 20200326978; 20200341767; 20200341769; 20200341770; 20200341771; 20200356366; 20200356369; 20200358704; 20200364334; 20200364376; 20200371960; 20200379766; 20200380402; 20200380539; 20200387375; 20200387382; 20200387537; 20200396198; 20200401565; 20210019268; 20210026643; 20210026770; 20210026934; 20210049016; 20210055954; 20210064504; 20210064880; 20210073375; 20210081296; 20210083954; 20210097142; 20210097484; 20210104253; 20210117200; 20210117204; 20210118103; 20210125055; 20210141642; 20210157715; 20210166248; 20210166684; 20210168083; 20210182175; 20210208673; 20210216327; 20210233134; 20210237483; 20210255890; 20210271486; 20210286299; 20210295976; 20210303194; 20210306977; 20210319193; 20210326138; 20210334019; 20210334926; 20210342150; 20210350407; 20210367901; 20210406028; 20210406137; 20220009657; 20220012329; 20220019436; 20220020143; 20220027459; 20220027460; 20220027468; 20220035634; 20220050904; 20220058024; 20220058662; 20220058663; 20220066830; 20220075622; 20220084085; 20220091986; 20220092173; 20220100514; 20220100516; 20220103440; 20220107830; 20220108471; 20220120168; 20220121738; 20220121935; 20220129343; 20220147359; 20220156079; 20220156251; 20220156461; 20220163874; 20220164231; 20220171717; 20220171731; 20220179673; 20220182697; 20220191097; 20220198014; 20220206807; 20220222077; 20220245337; 20220261539; 20220264187; 20220269854; 20220269915; 20220272504; 20220291892; 20220300830; 20220301579; 20220308876; 20220309905; 20220318020; 20220327312; 20220374415; 20220382546; 20220382547; 20220382549; 20220386261; 20220391101; 20220391214; 20220391251; 20220398312; 20220398382; 20220405251; 20230026945; 20230053981; 20230055511; 20230063976; 20230068640; 20230083617; 20230090140; 20230096891; 20230097318; 20230097390; and 20230100693.

1. A secure processing method, comprising:
providing a memory storing instructions and instruction tags, the instruction tags being stored securely and unmodifiably after generation and during program execution;
retrieving the stored instructions and instruction tags into a memory location;
fetching a specific instruction from the memory location into a hardware instruction processor concurrently with fetching a specific instruction tag associated with the specific instruction into a hardware tag processor, wherein the specific instruction tag contains information to enforce specific context-dependent behavior for the specific instruction; and
processing the specific instruction concurrently with processing the associated specific instruction tag, wherein absent a security exception, the processing of the specific instruction tag associated with the specific instruction is completed without stalling at or before a time of completion of the processing of the specific instruction, wherein the specific instruction tag is directly interpretable to enforce the specific context-dependent behavior of the associated specific instruction during execution, and the specific instruction tag specifies at least one operation requirement for the associated specific instruction.

2. The processing method of claim 1, wherein the hardware instruction processor receives a data tag augmenting a respective operand of the specific instruction or contents of a processor register, and
the data tag:
contains information that prevents unintended operations relating to the respective operand or contents of the processor register,
is stored securely and only modifiable by the hardware instruction processor or hardware tag processor, based on the specific instruction tag associated with the specific instruction, and
permits context-specific processing to be enforced using the specific instruction tag in conjunction with the data tag of the respective operand or contents of the processor register.

3. The processing method of claim 2, further comprising writing the contents of the processor register and the data tag associated with the contents of the processor register into the memory location, when allowed by the specific instruction tag associated with the specific instruction performing the write, and allowed by a data tag associated with the memory location, and wherein the data tag associated with the memory location is protected from unauthorized access and modification.

4. The processing method of claim 2, wherein the specific instruction is a transfer instruction, further comprising executing the transfer instruction to read data from a first memory location and the data tag associated with the first memory location into the processor register, and writing the data to a second memory location, selectively dependent on the specific instruction tag associated with at least the associated specific instruction comprising the transfer instruction and a data tag associated with the second memory.

5. The processing method of claim 1, wherein the hardware instruction processor receives data tags augmenting operands of the specific instruction or contents of at least one processor register,
wherein the data tags:
contain information that prevent unintended operations relating to the respective operands or processor registers by the hardware instruction processor and hardware tag processor,
are stored securely and only modifiable by the hardware instruction processor or hardware tag processor, based on the specific instruction tag associated with the specific instruction, and
permit context-specific processing to be enforced using the specific instruction tag in conjunction with the data tags of the respective operands or processor registers.

6. The processing method of claim 1, wherein the memory stores code for an executable program, and the instruction tags have a uniform size, and are regularly interspersed with the instructions of the code in the memory.

7. The processing method of claim 1, wherein the memory stores a sequence of instructions alternating with instruction tags for an executable program.

8. The processing method of claim 1, wherein the memory stores a plurality of instructions in first fields and a corresponding plurality of instruction tags in second fields, the first fields and second fields being adjacent within the memory, wherein a size of and a placement interval of each first field and second field within the executable code is predetermined.

9. The processing method of claim 1, wherein the memory comprises a level-one cache memory, wherein a single cache line containing the instruction also contains the specific instruction tag associated with the specific instruction.

10. The processing method of claim 9, wherein the single cache line has a first set of dedicated fields for storing a plurality of instructions and a second set of dedicated fields for storing a plurality of instruction tags, and wherein the first set of dedicated fields are directly read by the hardware instruction processor and the second set of dedicated fields are read by the hardware tag processor.

11. The processing method of claim 10, wherein the single cache line has a first dedicated field for the specific instruction and a second dedicated field for the specific instruction tag, and wherein the first dedicated field is directly read by the hardware instruction processor and the second dedicated field is directly read by the hardware tag processor.

12. The processing method of claim 11, wherein the memory stores executable code of a program organized as instructions interspersed with instruction tags are regular intervals, further comprising retrieving a program segment into the cache while aligning the specific instruction with the first dedicated field and the specific instruction tag with the second dedicated field.

13. The processing method of claim 1, wherein instruction tags specifying security operations for individual instructions are placed in variable-sized tag fields and placed within the executable code for a program, with a plurality of instruction tags within each variable-sized tag field that applies with a one-to-one correspondence to a plurality of instructions in the executable code that are adjacent to the field of instruction tags and wherein each variable-sized tag field containing instruction tags has information that indicates a size of the respective variable-sized tag field and how the instruction tags therein correspond one-on-one to instructions adjacent to the field of instruction tags.

14. The processing method of claim 1, wherein the instruction tags are variable size instruction tags, and are located adjacent to a corresponding instruction in a field of a program code binary, wherein each field containing an instruction tag has information that indicates a size of the adjacent variable size instruction tag and how the variable size instruction tag therein corresponds to the instruction.

15. The processing method of claim 1, wherein information contained in the instruction tag associated with the specific instruction, along with data tags associated with at least one of (i) operands of the respective instruction, (ii) a memory location targeted for use by the respective instruction, and (iii) a memory location targeted for modification by the respective instruction, together determine whether the instruction is able to complete successfully.

16. The processing method of claim 1, wherein the specific instruction tag associated with the specific instruction contains information that is used to check if an address of a memory location accessed by the specific instruction falls within a range of data memory addresses maintained in special registers identified by the specific instruction tag.

17. The processing method of claim 1, wherein the specific instruction tag associated with the specific instruction specifies if the specific instruction is allowed to at least one of: (i) perform an operation on a field holding an instruction, (ii) use a pointer to instructions maintained in memory; (iii) perform an operation on a field holding data, (iv) use a pointer to data maintained in memory, (v) perform a memory read of a memory location for use of retrieved data specifies that the memory location's data tag be set to a prespecified value after the memory read has been completed, (vi) be a destination of a control flow instruction of a specific type, and (vii) update a data tag of an operand modified by the specific instruction, to indicate that the final access on the operand has been completed.

18. A microprocessor, comprising:
a memory configured to securely store an instruction tag and to prevent or flag changes to the instruction tag and the associated instruction stored in the memory; and
a logic unit configured to:
receive and execute a series of instructions optionally dependent on data, each instruction having an associated instruction tag from the memory containing information to enforce predefined context-dependent behavior, and each datum having an associated datum tag containing information indicating limitations on behavior of the logic unit with respect to the datum, the logic unit being responsive to at least one instruction tag which specifies a plurality of operation requirements for the associated instruction;
prevent execution of an instruction unless the instruction is associated with a valid instruction tag authorizing execution.

19. The microprocessor of claim 18, wherein the datum tags:
contain information that prevent unintended operations relating to the respective operands or processor registers by the hardware instruction processor and hardware tag processor,
are stored securely and only modifiable by the hardware instruction processor or hardware tag processor, based on the specific instruction tag associated with the specific instruction, and
permit context-specific processing to be enforced using the specific instruction tag in conjunction with the data tags of the respective operands or processor registers.

20. A secure microprocessor, comprising:
a communication port configured to receive instructions and corresponding instruction tags from external to the secure microprocessor;
a cache configured to receive the instructions and instruction tags through the communication port, comprising a cache line having (i) memory locations for storing instructions, and (ii) memory locations for storing instruction tags accompanying each respective instruction;
a control transfer processing unit, configured to enforce control transfer restrictions based on at least a validity of instructions comprising a control flow instruction defining at least an entry point of each control transfer, selectively dependent on respective accompanying instruction tags for each respective instruction from the cache line;
a logic execution unit configured to process data based on the instructions and interacting with the control transfer processing unit dependent on the control transfer restrictions; and
a tag processing unit, configured to:
process the instruction tags having instruction execution restrictions;
enforce the instruction execution restrictions with respect to execution of the instructions from the cache line, access to resources, manipulation of data, and interaction with the control transfer processing unit to enforce control transfer restrictions; and
concurrently interact with the logic execution unit dependent on the instruction execution restrictions.
